(19) United States
(12) Patent Application Publication
(10) Pub. No.: US 2013/0246272 A1
(43) Pub. Date: Sep. 19, 2013

(54) SECURE MOBILE TRANSACTIONS

(71) Applicant: ONEID INC., Redwood City, CA (US)

(72) Inventor: STEVEN TODD KIRSCH, LOS ALTOS HILLS, CA (US)

(73) Assignee: ONEID INC., Redwood City, CA (US)

(21) Appl. No.: 13/796,820

(22) Filed: Mar. 12, 2013

Related U.S. Application Data
(60) Provisional application No. 61/609,848, filed on Mar. 12, 2012.
(60) Provisional application No. 61/609,840, filed on Mar. 12, 2012.
(60) Provisional application No. 61/609,861, filed on Mar. 12, 2012.

(51) Int. Cl. G06Q 20/38

(52) U.S. Cl. CPC G06Q 20/3821
USPC 705/44

(57) ABSTRACT

A method of providing secure information for a transaction between an access device and a relying party device may include sending, from the relying party device to the identity repository, a first transmission. The first transmission may include the identifier. The identifier may be associated with a user account and the user account may be maintained by an identity repository. The first transmission may also include an information request. The method may also include sending, from the identity repository to the access device, a second transmission including a request to authorize the transaction. The method may additionally include sending, from the access device to the identity repository, a third transmission including an indication that the transaction has been authorized. The method may further include sending, from the identity repository to the relying party device, a fourth transmission comprising information responsive to the information request.

### CROSS-REFERENCES TO RELATED APPLICATIONS

This application claims priority to the following two U.S. Provisional Patent Applications, and the entire disclosure of each of these applications are incorporated by reference into this application for all purposes:
U.S. Provisional Patent Application No. 61/609,848, filed Mar. 12, 2012 entitled “Methods and Systems for Secure Identity Management” (Attorney Docket No. 94276-833770(000400US));
U.S. Provisional Patent Application No. 61/609,840, filed Mar. 12, 2012 entitled “Methods and Systems for Secure Mobile Transactions” (Attorney Docket No. 94276-832683(000300US)); and
U.S. Provisional Patent Application No. 61/609,861, filed Mar. 12, 2012 entitled “Methods and Systems for Receiving Purchasing Information” (Attorney Docket No. 94276-834284(001100US)).

The following two regular U.S. patent applications (including this one) are being filed concurrently, and the entire disclosure of the other applications are incorporated by reference into this application for all purposes:
U.S. patent application Ser. No. ______, filed Mar. 12, 2013, entitled “Secure Mobile Transactions” (Attorney Docket No. 94276-868032(000310USNP)); and
U.S. patent application Ser. No. ______, filed Mar. 12, 2013, entitled “Secure Digital Invoice Processing” (Attorney Docket No. 94276-868033(000610US)).

### BACKGROUND

Personal computing devices have becomine an important part of the retail landscape. Smart phones, tablet computers, laptops, and personal computers are being used by large segments of the population to engage in retail, banking, and communication transactions. By necessity, these transactions require identity verification and communication security in order to avoid compromising sensitive data. Therefore, sensitive data has to either be remembered by a user or stored somewhere on a computing device. Sensitive data is often lengthy and complicated, and thus, it is unwieldy for users to be expected to remember and enter this information reliably.

Just as personal computing devices have recently gained popularity for engaging in secure transactions, attackers and malware creators have seized on this fertile new ground for criminal purposes. Users often have viruses and other types of malware operating on their user devices without their knowledge. These malicious software processes can often compromise the widespread use of computerized transactions to gain access to personal information. This personal information can be transmitted to distant locations and exploited long before users know their data has been compromised.

In contrast, most retail transactions still take place in a face-to-face manner between a purchaser and a merchant. Generally, purchasing terms are agreed upon verbally or are decided as an inherent part of the transaction. For example, a purchaser might bring a product to a point-of-sale, where a representative of the merchant may ask for certain purchasing options, such as a credit card number. The terms of the transaction are often left out in the open and are vulnerable to miscommunication errors and eavesdroppers. Therefore, improvements are needed in the art.

### BRIEF SUMMARY

The present invention relates generally to online, or virtual identities. More specifically, the present invention relates to methods and systems for using virtual identities to securely transfer information. Merely by way of example, the invention has been applied to a method of securely transferring transaction-related information and purchasing authorizations between an access device of a purchaser and a relying party device of a merchant. The methods and techniques can be applied to a variety of transactions, interactions, and identity management systems.

In one embodiment, a method of providing secure information for a transaction between an access device and a relying party device may include sending, from the relying party device to the identity repository, a first transmission. The first transmission may include the identifier. The identifier may be associated with a user account and the user account may be maintained by an identity repository. The first transmission may also include an information request. The method may also include sending, from the identity repository to the access device, a second transmission including a request to authorize the transaction. The method may additionally include sending, from the access device to the identity repository, a third transmission including an indication that the transaction has been authorized. The method may further include sending, from the identity repository to the relying party device, a fourth transmission comprising information responsive to the information request.

In another embodiment, a method of providing secure information for a transaction to a relying party device using an access device may include receiving, by the access device, an identifier. The method may also include providing the identifier such that it can be communicated to the relying party device. The method may additionally include receiving, from an identity repository, a request to authorize the transaction. The method may further include sending, to the identity repository, an indication that the transaction has been authorized.

In yet another embodiment, A system for providing secure information for a transaction between an access device and a relying party device may include one or more processors and a memory communicatively coupled with and readable by the one or more processors and comprising a sequence of instructions. The set of instructions, when executed by the one or more processor to receiving, from the relying party device. The first transmission may include an identifier and an information request. The instructions may further cause the processor(s) to match the identifier with an account associated with the access device. The instructions may also cause the processor(s) to send, to the access device, a second transmission comprising a request to authorize the transaction. The instructions may additionally cause the processor(s) to receive, from the access device, a third transmission including an indication that the transaction has been authorized. The instructions may further cause the processor(s) to send, to the relying party device, a fourth transmission including information responsive to the information request

Numerous benefits can be achieved by way of the present invention over conventional techniques. For example, embodiments of the present invention reduce the likelihood that malicious actors can intercept form data during a transaction. Additionally, embodiments of the present invention provide a system for reducing errors and inconveniences that may be introduced during verbal or written communication of transaction and purchasing information. These and other embodiments along with many of their advantages and features are described in more detail in conjunction with the text below and attached figures.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a simplified block diagram of an exemplary identity management system, according to one embodiment.

FIG. 2 illustrates a simplified block diagram of key storage for an identity management system, according to one embodiment.

FIG. 3 illustrates a simplified block diagram of a system for secure mobile transactions using identity repository software modules, according to one embodiment.

FIG. 4 illustrates a simplified block diagram of a system for secure mobile transactions using third-party software modules, according to one embodiment.

FIG. 5 illustrates a simplified swim diagram of transactions that may be involved with secure mobile transactions, according to one embodiment.

FIG. 6 illustrates a simplified block diagram of information requests and transaction descriptions, according to one embodiment.

FIG. 7 illustrates a simplified block diagram of information requests and transaction descriptions as used by various devices, according to one embodiment.

FIG. 8A illustrates a simplified flowchart of a method of providing secure information for a transaction between an access device and a relying party device, according to one embodiment.

FIG. 8B illustrates a simplified flowchart of a method of providing secure information for a transaction to a relying party device using an access device, according to one embodiment.

FIG. 8C illustrates a simplified flowchart of a method of providing secure information for a transaction between an access device and a relying party device using an identity repository, according to one embodiment.

FIG. 9 illustrates a block diagram of components for an exemplary operating environment in which various embodiments of the present invention may be implemented.

FIG. 10 illustrates a block diagram of an exemplary computer system in which embodiments of the present invention may be implemented.

FIG. 11 illustrates a simplified flowchart of a method of implementing one-click purcahsing using the identity repository for a transaction between an access device and a website, according to one embodiment.

FIG. 12 illustrates a simplified flowchart of another method of implementing one-click purchasing using the identity repository for a transaction between an access device and a website, according to one embodiment.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Described herein, are embodiments for securely providing information between a user and a merchant for use in association with a transaction. The information may be used to complete a purchase, to select an item, to select a purchasing method, to verify the identity of a purchaser or a merchant, to register an account, to make a donation, to leave a tip, to add notes or commentary to a purchase record, and/or the like. Prior to this disclosure, this type of information was commonly passed between the user and the merchant using verbal, written, or symbolic communication. For example, when purchasing a dinner at a restaurant, a user could provide a credit card number printed on a credit card medium by hand to the merchant, verbally ask the merchant to use the credit card to settle the transaction, provide a written signature to authorize the transaction, write a tip amount on the transaction receipt, and manually record the transaction in an expense book.

The manual transaction described above may be fraught with potential errors. During verbal communication, numbers or authorizations may be misheard by one of the parties. Handwriting may be difficult to decipher, particularly numbers used to describe payment. Errors in passing information between the user and the merchant may result in incorrect billing, processing delays, and general frustration on the part of both parties. Signatures may be forged.

More importantly, the information exchange described above is not secure. Credit card numbers are exchanged in the open, often with a magnetic strip that can be read by devices at almost every point of sale. Credit card numbers can be lifted, signatures can be copied, and purchasing authorizations can be reused to make fraudulent transactions. Additionally, when exchanging personal information, such as a name, address, phone number, or date of birth, the user may be exposed to identity theft. The information exchanged in the clear may be used to open fraudulent bank accounts, initiate loans, purchase property, and engage in transactions, along with many other activities with the potential to damage the financial and social reputation of the user.

Another problem associated with manual transactions relates to the sheer volume of information that consumers may be expected to remember. In order to complete a transaction, merchants may request personal information such as identification, names, addresses, shipping addresses, billing addresses, credit card information, credit card numbers, credit card verification (CCV) numbers, organizations, titles, Social Security numbers, birth dates, transaction amounts, bank account numbers, routing numbers, personal identification numbers (PINs), passwords, usernames, e-mail addresses, telephone numbers, hardware identification (ID) numbers, and/or the like. The embodiments discussed herein may be used to exchange any type of information in addition to the information listed above.

Instead of remembering sensitive information, consumers may keep written records in a purse or wallet that can be stolen, lost, or destroyed. Instead of writing down their sensitive information, other consumers may make the more serious mistake of storing their sensitive information on their mobile computing devices. It has been discovered that malware and other types of viruses may easily be configured to search for sensitive information on a computing device. Password files may be compromised and transmitted to an attacker resulting in fraudulent use of a consumer's banking information.

Users may also be vulnerable to an over-the-shoulder eavesdropping attack if they fail to properly shield their written and/or verbal communications from nearby onlookers. Consumers may also enter purposely or accidentally provide incorrect information. On the merchant side, incorrectly entered information may result in erroneous orders, shipments to the wrong location, incorrect contact information, and other problems.

Even if consumers could safely remember their sensitive information without writing it down and securely communicate this information to a merchant outside of the earshot of any eavesdropper, this process may represent an inconvenience. Depending on the amount of information that needs to be exchanged, this inconvenience may deter consumers from making purchases. The prospect of providing contact information, business information, shipping addresses, billing addresses, usernames, passwords, credit card information, and/or the like, every time a consumer wants to make a purchase may simply be overwhelming or inconvenient for many consumers. Each transaction may be a constant reminder to the consumer that they are giving away personal information that may be used for fraudulent purposes.

The embodiments described herein may be used to solve these and many other problems related to providing information securely in association with transactions between parties. In some embodiments, a secure repository, also referred to as an identity repository, may be used to store sensitive information for consumers. The identity repository may be remotely located geographically away from users at a secure location. The sensitive information at the identity repository may be encrypted, and the cryptographic keys needed to access the sensitive information may be stored at a separate physical location, such as on a user device. When providing transactional information, the identity repository may provide the information to the merchant, supplemented by information provided by the user.

In some embodiments, the user's identity repository account may be associated with an identifier, such as a username, a user code, a transaction code, and/or the like. The identifier may be provided by the identity repository to a user device prior to, or at the time of the transaction. Instead of communicating sensitive and often voluminous transactional information, the user may simply provide the identifier to the merchant using any means of communication. For example, the user may simply tell the merchant his/her identity repository username. The identifier may be entered into a merchant device, and transmitted to the identity repository. The merchant device may also transmit a request for information, such as a credit card number, a transaction authorization, a tip amount, and/or the like. The merchant device may also transmit information descriptive of the transaction, such as a price, a merchant name, and invoice number, and/or the like.

The identity repository may then determine what of the requested information can be provided by the identity repository and what information will need to be provided by the user. The identity repository can then send a transmission to the user device. The user device can display some of the information that is descriptive of the transaction to the user, and the user can provide information for the transaction, provide authorization for the transaction, and/or the like. The user device may also be configured to automatically respond without user interaction. The identity repository can then send the information responsive to the information request to the merchant device. The merchant can then use the information received to complete the transaction.

This disclosure is divided into three sections. First a basic overview of a secure identity management system will be provided. This secure identity management system can be used to store sensitive information away from a user device and provide that information when requested by a merchant device and authorized for release. Next, exemplary embodiments for securely providing information from the transactions will be presented. These embodiments will illustrate how to utilize the identity repository to securely provide sensitive information. Finally, an exemplary hardware system will be provided comprising network computing devices that can be used to implement the various embodiments disclosed herein.

### Secure Identity Management

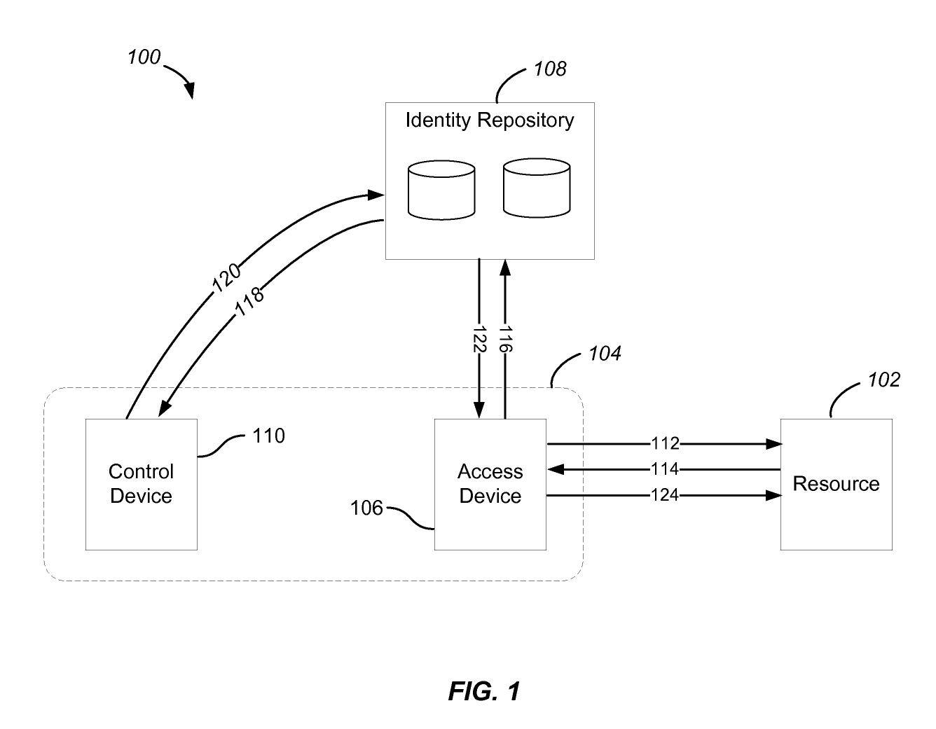

FIG. 1 illustrates a simplified block diagram 100 of a system for online identity management, according to an embodiment of the present invention. The system may be configured to use one or two user devices. At its most basic level, the system can use an access device 106. The access device 106 will typically be the device the user is using for an interaction. Second, an optional control device 110 may be used. The control device 110 may comprise a personal device, such as a smart phone, tablet computer, personal computer, and/or personal digital assistant (PDA) that is controlled by the user. Additionally, a remotely located identity repository 108 can be used in the interaction. The access device 106 can engage in the interaction with a resource 102. The resource can include a website, a database, a web service, and/or the like. Man-in-the-middle attacks can be reduced because cryptographic secrets can be transferred from user controlled endpoint devices securely, even if the identity repository is compromised by an attacker.

In this embodiment, the access device 106 (AD) may comprise a user device that is being authenticated to perform a transaction using a virtual identity. The control device 110 (CD) may comprise a second user device in the user's control that is used to set access rights for the users access device 106 and to perform OOB authentication/verification. The resource 102 (RP) may be defined as a party, typically a website, to which the user wishes the virtual identity to be authenticated and, optionally, with which to share attributes and perform additional transactions. The identity repository 108 (Repo) may be defined as an online database of encrypted credentials and attribute/value pairs. The identity repository 108 may be remotely located and may be operated by a third party that is not associated with either the user or the resource 102. Each access device 106 and control device 110 may have a unique identifier, referred to as a Device ID (DEVID). Additionally, each user may have a unique identifier, or Global User ID (GUID), that is stored on the access device 106 and on the control device 110 and can be used to index information stored on the identity repository 108. Finally, each user may have a second user identification (UID) that comprises a site-specific identifier for the user for the resource 102. The UID can be derived at least in part from the fully-qualified domain name associated with the resource 102.

In one embodiment, the access device 106 and the identity repository 108 can be required in order to complete a transaction. The control device 110 can be a separate device from the access device 106, or the same physical device can be used as both the access device 106 and the control device 110. For example, a laptop can function as both the access device 106 and the control device 110. A mobile phone could also function as both devices. Participation by the control device 110 may optionally be required in a transaction to provide a higher level of assurance that the user has consented to the transaction. This process will be described further below. At any time, the user may choose to use a higher security mode comprising a higher level of assurance. The user can also choose to lock out any individual device or force the individual device into a higher security mode. These actions can be performed on any device registered by the user. Furthermore, some embodiments may employ a special “tripwire” feature so that, if a password or PIN is not entered when requested, a device will be prevented from supplying any subsequent digital signatures until the requested password or PIN is provided.

As used herein, transactions may use a varying “Level of Assurance” (LoA) mode. In one embodiment, four modes are supported: disabled, enabled with no security, password with a timeout, and out-of-band (OOB) authorization required with an optional PIN and timeout. Users can control the LoA mode required by each type of transaction. To minimize risk in the case of a lost user device, devices can be immediately turned off from any remaining registered device that the user still controls. In one embodiment, the identity repository 108 can enforce the greater of two LoA modes: the level requested by the user and the level requested by the resource 102. This can ensure that organizations, such as financial institutions, can be compliant with regulations regardless of the security level requested by the user. For example, a bank could require that, for transaction to be approved, a PIN should be entered on the control device 110 within a time period, such as 5 minutes. For banks, two factor authentication may be required by FFIEC regulations.

According to one embodiment, the conditions in an LoA mode may be based on information related to the devices owned or operated on behalf of the user or devices authorized for the user with limits on how devices can be used in the transaction. For example, a desktop computer in a secure work area may have a higher transaction value limit than a mobile device. A mobile device with a password-to-unlock feature may have a higher transaction value limit than an unlocked mobile device. One of ordinary skill in the art would recognize many variations, modifications, and alternatives.

The conditions in an LoA mode can include information related to preferences established by one of the parties, including transaction value limits, time periods during which transactions are initiated, geographic locations where the transaction is initiated, histories of returns or invalidated transactions, user reputations, number of transactions within a particular time period, or the like. The conditions in an LoA mode can also include cumulative data, including thresholds for the number of items in a single purchase, cumulative costs of items in a single transaction, cumulative amount spent in a particular time period, and/or the like. Therefore, the conditions in an LoA mode can comprise a cost threshold for a single transaction, a cumulative cost threshold for transactions during a time period, or a time limit since a password was provided to a user device. These conditions can be used to define almost every aspect of a transaction/interaction, such that a party can set specified authentication levels that add security to high-value transactions or transactions where the risk of fraud is high. It should be noted that if preferences received from a party contradict preferences already stored on the device executing this method, the more conservative or secure preferences can be used in the transaction.

According to one embodiment, the conditions in an LoA mode may also include conditions related to types of transactions. For example, purchasing certain types of goods, such as jewelry, cars, software, collectibles, or the like, that are more likely to be involved in theft and fraud can require higher levels of authentication. The conditions can also include conditions on payment options. For example, purchasing items with a credit card may require a first authorization level, while paying for items with a debit card may require a second authorization level. The preferences can also include conditions on methods of shipping or shipping locations. For example, shipping items to a Post Office Box or to an address different from the billing address may require a higher authorization level.

Each of the conditions of an LoA mode may be associated with one or more authentication levels. If the condition is met, then the specified authentication level (or a higher authentication level) should be used in the transaction/interaction. An authentication level can comprise requiring an indication that the transaction is approved to be received by a user module operating on a user device. For example, a user may be required to provide input indicating that they have reviewed the transaction and approve. An authentication level can also comprise notifying additional devices that are associated with the user. For example, a notification can be sent to a user's cell phone or tablet computer for a transaction that was initiated on the user's desktop computer. An authentication level can comprise requiring a PIN or password to be received by one or more of the additional devices associated with the user, such as a control device. An authentication level can comprise a waiting period between initiating the transaction and final approval. In one embodiment, an authentication level may require human contact by a representative of the relying party. In another embodiment, an authorization level can require a third-party to authenticate the transaction, such as the identity repository.

In one embodiment, an LoA mode can also specify a timeout period associated with each PIN and/or password. For example, one mode could specify that a password should be entered into the access device within the last three hours preceding the transaction/interaction. As another example, one mode could specify that a PIN should be entered into the control device within five minutes preceding the transaction interaction. The timeout period may be affected by other factors, such as the time of day of the transaction, a cost associated with the transaction, the security of the device used in the transaction, a cumulative cost of a set of transactions, and/or any other factors described above. For example, a timeout period may be longer on a secure device, whereas the timeout period may be shorter on an insecure device.

What follows is a brief description of one exemplary transaction. Each step in this exemplary transaction will be discussed in more detail later in this disclosure. Returning to block diagram 100 of FIG. 1, the access device 106 can access the resource 102 (112). In response, the resource 102 can return a random digital challenge and request that the access device 106 return the challenge signed by two or three signatures (114). Next, the access device 106 can generate one or more cloud repository keys. The access device 106 can pass the digital challenge and the one or more cloud repository keys to the identity repository 108 (116). If the access device 106 is password protected and a timeout period is exceeded, the user may supply digital proof that the user knows the password to the access device 106. The digital proof may comprise a guess of the password. In one embodiment, the digital proof is not transmitted off of the access device 106, not even in a hashed or encrypted form. Confirmation that the user knows the password is provided by signing a challenge from the identity repository 108.

The identity repository 108 can compare a first LoA mode specified by the access device 106 with a second LoA mode specified by the resource 102 to determine whether an OOB approval should also be required for the transaction. If an OOB approval is determined to be required by either the access device 106 or the resource 102, the identity repository 108 sends a challenge to the control device 110 (118). In one embodiment, certain details of the original transaction can be displayed to the user on the control device 110, thus eliminating the possibility of a man-in-the-browser attack or a man-in-the-middle attack. A PIN can also be requested by the control device 110. If a PIN has not been provided within a timeout period, the control device 110 may prompt the user to enter the PIN. In one embodiment, any PIN guess entered by the user never leaves the control device 110. Instead, the control device 110 can rely on asymmetric cryptography and another challenge from the identity repository 108 to prove to the identity repository 108 that the user has supplied the correct PIN. This process will be described further later in this disclosure. Approval for the transaction, along with any signed challenges, can be sent back to the identity repository 108 (120). In one embodiment, the control device 110 signs the challenge from the resource 102 using a private key stored on the control device 110.

The identity repository 108 can enforce the LoA mode on the transaction. Therefore, the identity repository 108 can withhold its signature on the challenge unless all of the requirements of the LoA mode have been met. If the identity repository 108 determines that all of these requirements have been met, the identity repository 108 can sign the challenge using its private key. The identity repository 108 can then send the signature of the control device 110 and the signature of the identity repository 108 to the access device 106 (122). At this point, the access device 106 can sign the challenge and return all two/three signatures to the resource 102 (124). Additionally, the access device 106 can send a user ID (the site-specific user ID). The resource 102 can look up a set of public keys that are associated with the UID to verify that all three signatures correspond to the public keys and grant access to the user. In one embodiment, the public keys can be unique to the resource 102. In other words, each website will be associated with its own set of public and private key pairs. This can assure a user's privacy and prevent website tracking. Because the resource 102 interacts with the access device 106, the identity repository 108 can be prevented from determining which resources the user has visited. The identity repository 108 simply holds an encrypted block of data and receives commands to read and write encrypted keys and values.

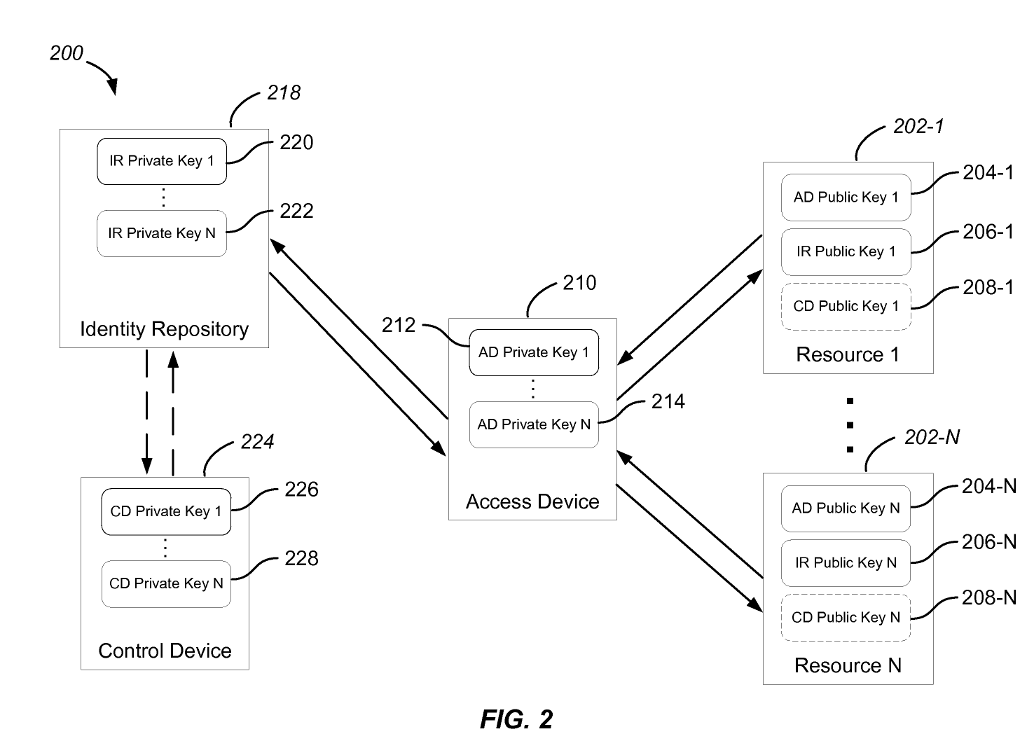

FIG. 2 illustrates a simplified block diagram 200 of a system for online identity management with distributed secrets, according to an embodiment of the present invention. The embodiment of FIG. 2 uses a subset of the keys that may be used by various embodiments of the identity management system. Note that the remaining keys may be operative in the background of the system illustrated by FIG. 2. Additionally, the keys in FIG. 2 may be derived from one or more of the keys not explicitly shown in FIG. 2. As described earlier, an access device 210 may engage in a transaction with a number of resources 202. Each of the resources 202 may have a set of public keys associated with a UID of a user of the access device 210. For example, resource 202-1 stores two to three public keys for the UID 210, namely an AD public key 204-1 that is associated with the access device 210, an IR public key 206-1 that is associated with an identity repository 218, and, optionally, a CD public key 208-1 that is associated with a control device 224.

When the access device 210 first attempts a transaction with one of the resources 202, the access device 210 can provide the public keys 204, 206, 208 to the resources 202. Each of the resources 202 may have a unique set of public keys. In providing the public keys 204, 206, 200, the access device 210 may create the AD public keys 204, and the IR public keys 206 and the CD public keys 208 can be obtained from the identity repository 218 and the control device 224, respectively.

When initiating a transaction, the resources 202 can send a digital challenge to the access device 210 to authenticate a virtual identity. When the LoA mode requirements of each device of been met, each device may sign the digital challenge using the private keys that correspond to the public key of the particular resource. For example, a digital challenge sent from resource 202-1 could be signed by the access device 210 using AD private key 212 and the identity repository 218 using the IR private key 220. Optionally, the digital challenge could also be signed by the control device 224 using the CD private key 226. Each of these devices may enforce one or more requirements of the LoA mode before signing. For example, the control device 224 may require a PIN from the user, and the identity repository 218 may require an OOB authorization from the control device 224. The access device 210 may require a signature from the identity repository 218 as well as a signature from the control device 224 before signing the digital challenge. Other embodiments may enforce different requirements as described elsewhere herein.

In one embodiment, each of these keys are actually stored on their respective devices. In another embodiment, a master key is stored and each device from which the keys in FIG. 2 are deterministically derived when they are needed. For example, the AD private key 212 may be derived from an Access Device Key (ADK) for the access device 210.

### Secure Mobile Transactions

The “transactions” referred to in the above discussion should be interpreted broadly. In some cases, a transaction may involve a commercial purchase. In other cases, a transaction may simply involve retrieving securely stored information from the identity repository and decrypting the information for use by a merchant. In other cases, a transaction may include registering for an event, membership, service, or lottery. The transaction may also include verifying the identity of a user to a merchant. Transactions may be in person, over the phone, or via other means of communication such as e-mail, text message, voice mail, physical letters, and/or the like.

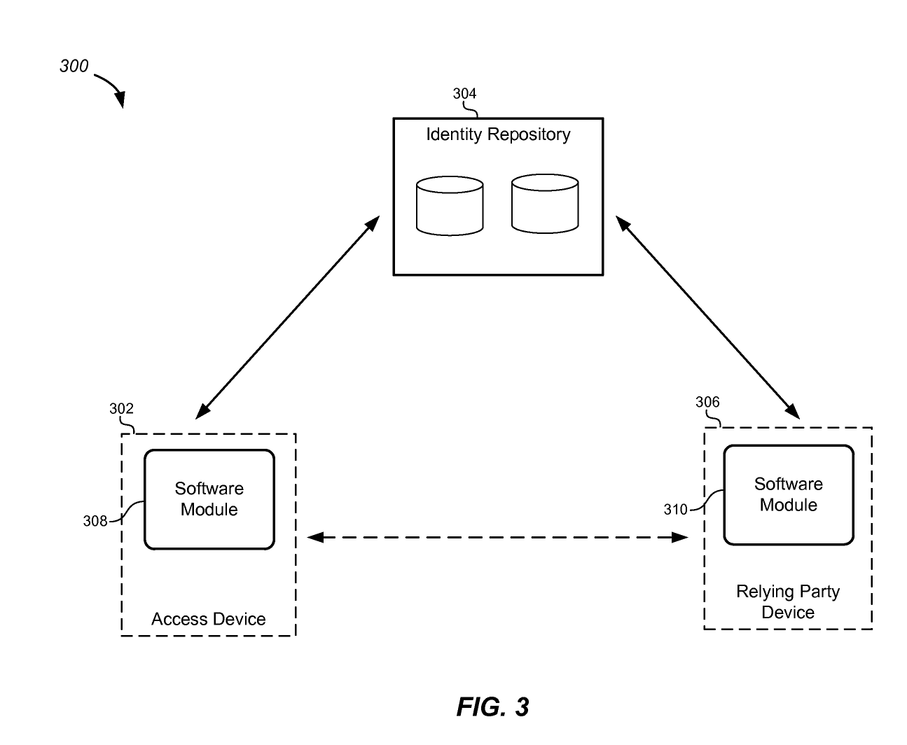

Generally, the transactions described herein may be associated three devices. FIG. 3 illustrates a simplified block diagram 300 of a system for secure mobile transactions using identity repository software modules, according to one embodiment. The first device used in exemplary transactions may be an access device 302. As described in the previous section, the access device 302 may be operated by a user, and thus may also be referred to herein as a user device. The access device 302 may comprise a cell phone, a smart phone, a PDA, a laptop computer, a tablet computer, a desktop computer, and/or the like. The access device 302 may be operated by a user or by a group of users, such as a family, business, or group of friends. The access device 202 may be used by the user to participate in a transaction where the user plays the role of a purchaser, applicant, or transaction partner.

The transactions described herein may also include a relying party device 306. As described above, a relying party may include any party that is relying on an identity repository to verify, provide, or authenticate information related to the transaction. The relying party may comprise a retailer, wholesaler, a bank teller, or any other party participating in a transaction with the user. The relying party device 306 may be any combination of hardware and/or software operated by the relying party or an agent of the relying party to participate in the transaction. For example, the relying party device 306 may include a card reader, a cash register, a point-of-sale device, a barcode reader, a smart phone, a notebook computer, a workstation, a laptop computer, a desktop computer, a thin client, and/or the like. The relying party device 306 may be used to receive an identifier provided by the user or access device and to send the identifier and/or a request for information to an identity repository. As used herein, the relying party may also be referred to as a merchant, and the relying party device 306 may also be referred to as a merchant device. These terms may be used interchangeably.

The transactions described herein may also include an identity repository 304. As described in the previous section, the identity repository 304 may be operated by an entity such as a OneID® (the current assignee) to store, manage, and provide virtual identities and data storage. The identity repository 304 may be geographically remote from both the access device 302 and the relying party device 306. In other words, the identity repository 304 may store information in a facility that is separate from any facility housing the access device 302 and/or the relying party device 306. The computer hardware used to implement each of the identity repository 304, the access device 302, and the relying party device 306 may be distinct and physically separate. The identity repository 304 may be separated from the access device 302 and/or the relying party device 306 by a distance of more than 10 miles, 20 miles, 50 miles, and/or the like, and thus may be considered geographically remote.

The identity repository 304 may be a fully encrypted repository that stores user data in encrypted field/value pairs. Encrypted fields may be received from the access device 302 and the encrypted values may be provided in response. In some embodiments, the identity repository may provide a signature for a transaction once requirements have been met. These requirements may be referred to as a level of assurance (LoA) to be discussed elsewhere in this disclosure.

The access device 302 may have operating thereon a software module 308 that is compatible with the identity repository 304. In one embodiment, the access device 302 may comprise a smart phone may include a software module 308 comprising an app from an online app store such as those provided by Apple®, Google®, and so forth. Similarly, the relying party device 306 may have operating thereon a similar software module 310 that is compatible with the identity repository 304. Software modules 308 and 310 may be provided by an entity associated by the identity repository, such as OneID®. This disclosure may refer to the access device 302 or the relying party device 306 receiving transmissions. In some embodiments, software modules 308 and/or 310 may receive these transmissions on the access device 302 and/or relying party device 306.

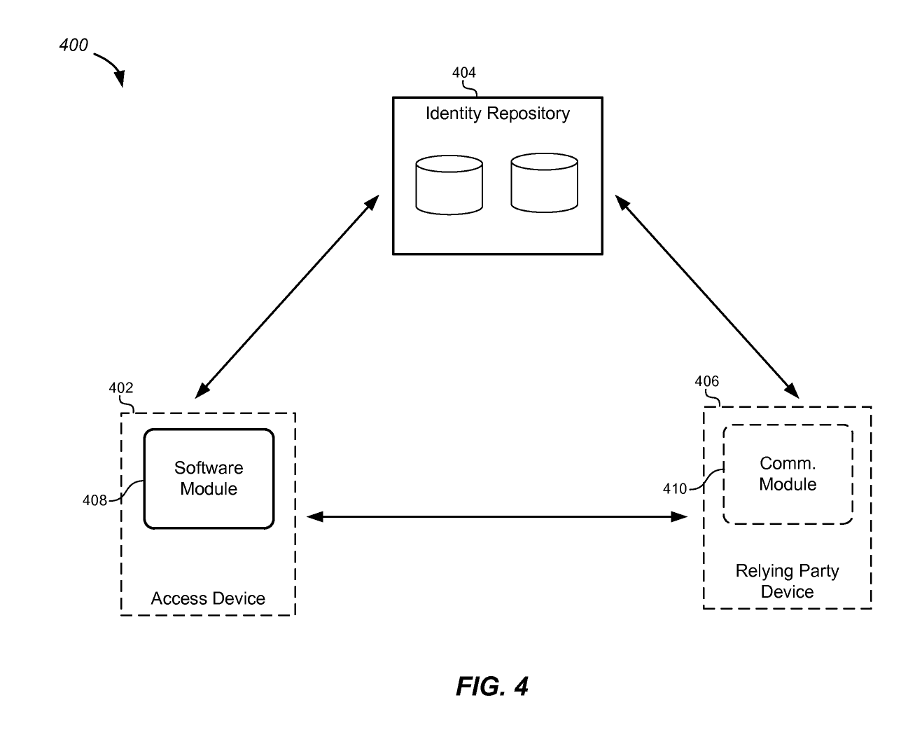

FIG. 4 illustrates a simplified block diagram 400 of a system for secure mobile transactions using third-party software modules, according to one embodiment. Block diagram 400 is similar to block diagram 300 of FIG. 3, except the software operating on the access device 402 and/or the relying party device 406 need not be a specialized software module provided by or associated with the identity repository 404. For example, the relying party device 406 may include a communication module 410 provided by a third-party software provider. The communication module 410 may be an e-mail client, a text message application, and/or the like. The communication module 410 may be used to send a communication to the identity repository 404 that includes an identifier and/or a request for information. For example, a merchant may use his cell phone to send an e-mail to an address associated with the identity repository 404, such as “transactions@oneid.com” where the e-mail includes the identifier and/or information request.

The access device 402 may continue to operate with a software module 408 that is associated with the identity repository 404. Other configurations may also be used by various embodiments. For example, both the access device 402 and the relying party device 406 may use third-party communication modules. In other cases, the access device 408 may use a third-party communication module and the relying party device may use a specialized software module associated with the identity repository 404. In one embodiment, both the access device 402 and the relying party device 406 may use an e-mail client to communicate with the identity repository 404 without requiring a software module associated with the identity repository 404.

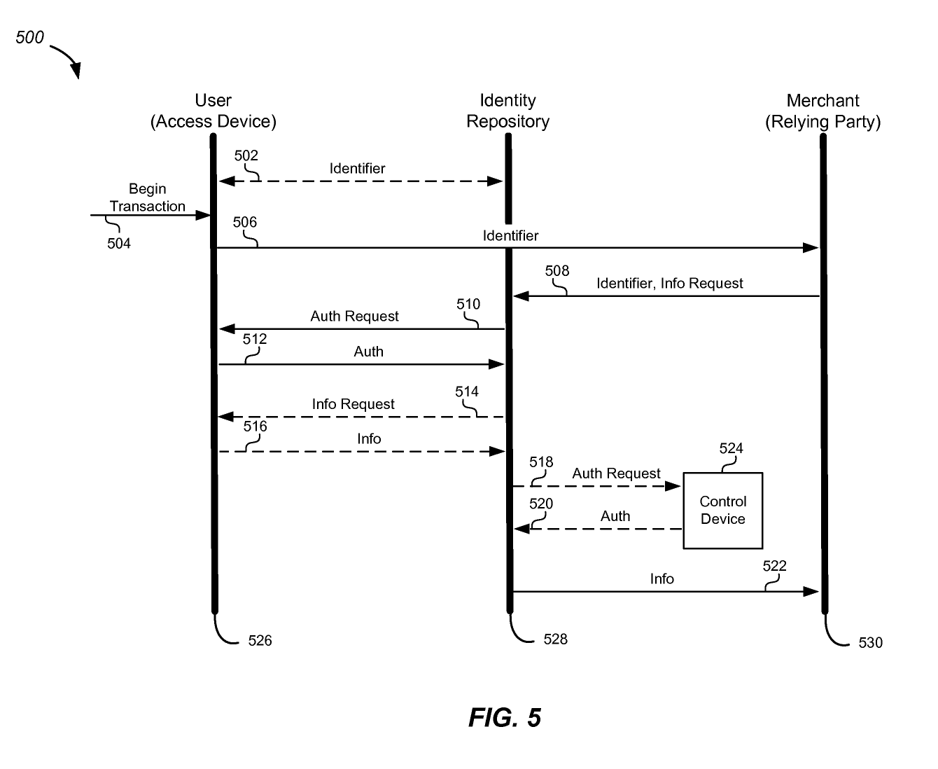

FIG. 5 illustrates a simplified swim diagram 500 of transmissions that may be involved with secure mobile transactions, according to one embodiment. First, an identifier may be exchanged between an access device 526 and an identity repository 528 (502). In some embodiments, the identity repository 528 may transmit the identifier to the access device 526, while in other embodiments, the access device 506 may transmit the identifier to the identity repository 528. The identifier may comprise many different numbers, codes, usernames, and/or the like, will be discussed in greater detail below.

In this particular embodiment, the identifier may be exchanged between the access device 526 and the identity repository 528 prior to the beginning of the transaction. For example, the identifier may be exchanged when a virtual identity is created by the identity repository 528 or when the user signs up for a particular service provided by the identity repository 528. The identifier, or a version of the identifier, may be used for many different types of transactions at different times. In other embodiments (not shown) the identifier may be exchanged at the time of the transaction. For example, the access device 526 and the identity repository 528 may exchange a single-use, transaction-specific identifier with an expiration time/date.

The identifier may then be received by the relying party device 530 (506). The identifier may be received using many different forms of communication. In one embodiment, the access device 526 may display the identifier to the user, who then tells the merchant the identifier. For example, the user may tell the merchant the name of his/her identity repository and a number, such as “my OneID account number is 531-6285-99.” In another embodiment, the user may have memorized the identifier, and the access device 526 need not display anything to the user in order for the relying party device 530 to receive the identifier. In another embodiment, the user may present the merchant with an identification card associated with the identity repository 528 from which the merchant can read the identifier.

The relying party device 530 may receive the identifier through any input device available. In one embodiment, the merchant may type the identifier using a keyboard device. In another embodiment, the merchant may scan an ID card provided by the user with a card reader, barcode reader, NFC reader, and/or the like. In another embodiment, the user may provide the relying party device 530 with the identifier. For example, the user may enter the identifier into a keypad, or the user may swipe and identification card using a point-of-sale device.

In some embodiments, the merchant may be familiar with the user and may already know the identifier. In some embodiments, the user may provide a form of identification such as a drivers license, credit card, identification card, passport, visa, and/or the like, and the merchant may use that form of identification to look up the identifier. For example, the merchant may search a database using the user's last name to look up the identifier. In this case, the merchant may store a database that includes the identifiers of registered users. The merchant may enter the form of identification, and the relying party device 530 may retrieve the identifier from a database. In this case, the database may automatically provide the identifier to the relying party device 530.

In some embodiments, the merchant may receive the form of identification (drivers license, passport, etc.), and send information from the form of identification to the identity repository 528. The identity repository 528 may then use the information from the form of identification to look up the identifier associated with the user and send the identifier to the relying party device 530. For example, the merchant could send the first and last name of the user to the identity repository 528. The identity repository 528 could then use the first and last name to look up an identity repository account number associated with the user, and send the account number to the relying party device 530. In some embodiments, the information from the form of identification may be used as the identifier that is sent to the identity repository 528. In this case, the identity repository 528 need not send any additional identifier to the relying party device 530.

In another embodiment, the access device 526 may transmit the identifier to the relying party device 530. The access device 526 may transmit the identifier using Bluetooth® technology, the 802.11 wireless protocol, NFC transmissions, e-mail transmissions, text message, radio communication, and/or the like. Some embodiments may provide added security by encoding the identifier before it is communicated to the merchant or relying party device 530. For example, the screen of the access device 526 may display a Quick Response (QR) code that can be read by the relying party device 530.

After receiving the identifier, the relying party device 530 may send a transmission to the identity repository 528 that includes the identifier (508). The identity repository 528 may use the identifier to look up a user account or a particular transaction in a transaction table. Additionally, the relying party device 530 may send an information request. The information request may include information that is desired to be part of the transaction.

The requested information may include characteristics of a product or service, such as a size, color, room type, start date, end date, price option, hardware option, software option, location, and/or the like. For example, the information request may request a size and color of an article of clothing. In another example, the information request may request a bed size, a room type (suite, studio, or ground-floor), smoking option, check-in date, and/or check-out of date for a hotel room.

The requested information may also include characteristics of the user, such as a first name, a last name, a shipping address, a billing address, an age, a birth date, a gender, membership numbers, eye color, hair color, height, weight, and/or the like. For example, the information request may request a home address and occupation for a cleaning service. In another example, the information request may request a birth date, first name, and/or last name for a membership registration.

The requested information may also include characteristics of the transaction, such as a payment method, a credit card number, a bank account number, a PIN, a password, a CCV number, an expiration date, a shipping address, a billing address, payment dates, a tokenized credit card packet, a digital signature authorizing the transaction, a bank number, a routing number, a bank address, and/or the like. For example, the information request may include a request for a credit card type, a credit card number, a credit card expiration date, a credit card CCV number, and/or a digital signature authorizing the merchant to charge the account for a particular currency amount.

In some embodiments, the relying party device 530 may also send information descriptive of the transaction to the identity repository 528. The information descriptive of the transaction may include a merchant name, a merchant address, a transaction date, a list of products or services being purchased, a cash register number, a merchant employee name or identifier, a transaction number, an invoice number, warranty and/or return information, notes entered by the merchant, and/or the like. For example, the information descriptive of the transaction may include a merchant name, a list of items purchased, a total price, item prices, taxes charged, and/or the like, for a retail purchase.

In some embodiments, the information descriptive of the transaction may be recorded in a log at the identity repository 528 to identify the transaction in the future for auditing purposes or for the user's benefit. In some embodiments, the information descriptive of the transaction may be sent to the access device 526 such that the user can review the details of the transaction before providing a payment option, signing a transaction, and/or otherwise authorizing the transaction. In some embodiments, the information descriptive of the transaction may be used to generate a digital receipt that may be provided by/to the access device 526, the identity repository 528, and/or the relying party device 530.

The identity repository 528 may use the identifier to look up an account associated with the user and/or the access device 526. In some embodiments, the identity repository 528 may then make certain determinations regarding the transaction and/or the merchant 530. For example, the identity repository 528 may determine that prior transactions from the merchant 530 may have been rejected by the access device 526, and thus the identity repository 528 may automatically reject the transaction. A notification may then be sent to the access device 526 and/or the relying party device 530. In some embodiments, the identity repository 528 may include user preferences stored thereon that direct the identity repository 528 to automatically approve certain transaction types without requiring explicit authorization from the user device 526. The identity repository 528 may also automatically provide information responsive to the information request according to user preferences.

In some embodiments, the identity repository 528 may compare various LoA levels as provided by the relying party device 530, access device 526, and/or the identity repository 528 itself. And LoA level for the transaction may be selected by the identity repository 528, and the requirements of that LoA level may then be enforced by the identity repository 528. For example, the selected LoA level may require an out-of-band (OOB) authentication to be provided by the user based on a cost of the transaction. In another example, the selected LoA level may require the user to enter a PIN at the user device 526 if a certain amount of time has passed since a previous approved transaction. In another example, the selected LoA may require a higher level of authentication from the user based on a geographic location of the transaction (which may be determined automatically using a GPS device from the access device 526 and/or relying party device 530). In another example, the selected LoA may require a certain level of authentication from the user based on a transaction type, an access device type, a relying party device type, a price, a product type, the particular merchant, the merchant type, a time or date of the transaction, and/or the like.

The identity repository 528 may then send an authorization request to the access device 526 (510). The authorization request does not need to be in any particular form. In some embodiments, the authorization request may comprise a simple transmission with the data packet to the access device 526. In other embodiments, authorization request may be included in a transmission with the information request, as well as information descriptive of the transaction.

The access device 526 may provide an authorization for the transaction to the identity repository 528 (512). In some embodiments, the access device 526 may be configured to automatically provide the authentication based on user preferences, the transaction type, the price, the location, the merchant, and/or the like. For example, the access device 526 may be configured to automatically approve transactions for less than $15, transactions that are within 10 miles of the user's home address, transactions that take place between 10 AM and 5 PM, transactions involving a particular brand of supermarket, and so forth.

The authentication sent to the identity repository 528 need not have any particular form. In some embodiments, the identity repository 528 and/or the relying party device 530 may provide a digital challenge, such as a nonce, to the access device 526. The authentication may comprise a digital signature provided by the access device 526 of the digital challenge. The signature may be provided using an access device private key, and the corresponding public key may be known to the identity repository 528 and/or the relying party device 530. This type of authentication is described in greater detail in the “Secure Identity Management” section above in this disclosure. In some embodiments, the authentication may be securely transmitted to the identity repository 528. In other embodiments, the indication may be transmitted in the clear. The authentication may be encoded or may be a simple yes or no response. In some embodiments, simply providing information that is responsive to the information request may be regarded as an authorization of the transaction. In this case, no explicit authorization needs to be sent, as simply responding to the information request may comprise an indication that the transaction has been authorized. In some embodiments, any response other than a rejection of the transaction may be considered an authorization of transaction.

In some embodiments, the identity repository 528 may send the information request to the access device 526 (514). In some cases, all of the information responsive to the information request may be stored at the identity repository 528, and thus the information request need not be sent to the access device 526. In other cases, all of the information request may be sent to the user access device 526. The information responsive to the information request may then be provided by the user or may be provided automatically by the access device 526. In some cases, the identity repository 528 may send at least a part of the information request to the access device 526. In these cases, the information responsive to the information request may be provided by the access device 526, the user, and/or the identity repository 528, depending on where the information is available.

The information request sent from the relying party device 530 may be repackaged, reformatted, or otherwise altered before at least a portion of the information request is sent to the access device 526 from the identity repository 528. The information request may be reformatted to match field/value pairs as they may be stored by the identity repository 528. The information request may also be reformatted to include queries that may be presented to and understood by a user or the access device 526. For example, a portion of the information request may be reformatted to display “please select a payment method” on a display of the access device 526. In some embodiments, the information request sent from the identity repository 528 may include instructions, options, and/or conditions to be executed and/or presented by the access device 526. For example, the identity repository 528 may send the access device 526 a list of payment options (Visa, American Express, MasterCard, etc.) with instructions to present the payment options to the user and solicit a selection of at least one payment option.

In some embodiments, the identity repository 528 may add additional information to be requested from the access device 526. For example, the identity repository may request information describing the transaction from the access device 526. The user may then enter notes to be stored with the transaction record at the identity repository 528, such as “Valentine's Day present for my wife,” or “concert tickets.” The identity repository 528 may also need additional information in order to approve a transaction, such as a passcode or other form of verification. This additional information need not be sent to the relying party device 530 as part of the transaction.

In some embodiments, the access device 526 may store thereon user preferences that may be used to respond to the portion of the information request sent from the identity repository 528. For example, the access device 526 may store user preferences such as a preferred payment method, clothing sizes, preferred room rates, shipping address, and/or the like. The access device 526 may then automatically provide this information to the identity repository 528 without requiring user selection explicitly.

In some embodiments, some information responsive to the information request may need to be entered by a user. In this case, the access device 526 may present a question or a list of possible selections to the user and allow the user to enter a response. For example, a user may enter a PIN using a touchscreen. In another example, the user may provide a graphical signature using a touchscreen device, a stylus, a fingertip, a touchpad, and/or the like.

Some embodiments may also present the opportunity for the user to explicitly authorize the transaction. For example, the access device 526 may display a question such as “do you authorize a transaction with ACME Inc. to purchase five widgets for a total of $25?” The user may be presented with a yes or no input. The user may also be presented with a signature input, checkbox, and/or the like. In cases with simple transactions, the user may simply be presented with a question such as “do you authorize the current transaction?” A yes or no answer may be provided.

In some embodiments where information responsive to the information request may be provided without user inputs, the access device 522 may still display such information to the user for confirmation. In this case, the identity repository 528 may provide some of the information responsive to the information request to the access device 526. The access device 526 may also supply some of the information responsive to the information request. The access device 526 may then display the selections made by the access device 526 and/or the identity repository 528 to the user for confirmation. The user may accept the automatically provided information, or the user may alter some of the automatically provided information. For example, the identity repository 528 may store a user preference to use a first credit card as the payment method. The selection of the first credit card may be provided to the access device 526 and displayed to the user. For this particular transaction, the user may instead choose a second credit card as the method of payment.

In some embodiments, user inputs that alter the automatically provided information responsive to the information request may then overwrite the existing information in the user preferences stored on the access device 526 and/or the identity repository 528. In some embodiments, the user may be given the option to apply the changes to this transaction only, or to apply changes to all future transactions.

In some embodiments, a subset of the information responsive to the information request that was automatically provided by the access device 526 and/or the identity repository 528 may be presented to the user for verification/alteration. The subset of information may be selected based on user preferences. For example, the identity repository 528 may store a first credit card as the preferred payment method. However user preferences may dictate that the user be provided the opportunity to verify/alter the preferred payment method for transactions over a threshold amount, such as $25. The user may be provided with an indication on the access device display that the first credit card is the preferred option, but may still allow the user to alter the selection.

After any requested information has been provided by the access device 526 or user inputs, at least a portion of the information responsive to the information request may be sent to the identity repository 528 (516). Additionally, other information requested by the identity repository 528 and/or supplied by the access device 526 may be sent to the identity repository 528 for storage or transmission to the relying party. For example, the user may add a description to the transaction, such as “Valentine's Day present for my wife.” This description may or may not have been requested by the identity repository and/or the relying party device 540. In any case, the additional information provided by the user may be sent to the identity repository 528 as well as the relying party 530.

In some embodiments, an LoA requirement may require the identity repository 528 to perform an OOB authorization using a control device 524. Control device authorization is described earlier in this disclosure in the “Secure Identity Management” section. An authorization request may be sent to the control device 524 (518). The user may then be prompted to explicitly authorize the transaction, and/or provide a PIN for verification. Alternatively, the control device 524 may be configured to automatically provide an authorization without requiring a user response depending on the LoA, the transaction type, and user preferences.

The control device 524 may send an indication that the transaction is authorized back to the identity repository (520). In some embodiments, the control device 524 may sign a digital challenge, such as a nonce, provided by the identity repository 528 and/or the relying party device 530. In some embodiments, the nonce may be generated by the control device 524 as a function of the transaction, the current time, the current place, and/or the like. The authorization may be generated using a control device private key. The control device public key may be known or accessible by the identity repository 528 and/or at the relying party device 530.

After receiving authorization(s) for the transaction, the identity repository 528 may send information responsive to the information request to the relying party device 530. The information responsive to the information request may include an indication that the transaction is authorized from the access device 526. The information responsive to the information request may also include a tokenized credit card indication, a digital signature authorizing use of a credit card number, and/or other product, service, or transactional option selections.

Additionally, the identity repository 528 may send other information to the relying party device 530 that was not directly responsive to the information request. This additional information may include descriptions or notes provided by the access device 526. This additional information may also include contract terms, revised contract versions, terms of sale, and/or any other information that may need to be transmitted from the access device 506 to the relying party device 530.

The steps in the transaction described above are merely exemplary. The order in the steps, the sending and receiving parties, and the information passed back and forth may be altered according to the needs of a particular embodiment. For example, the authorization request (510) and the information request (514) may be combined into a single transaction or separated into two individual transactions. Other modifications will be readily apparent in light of this disclosure.

In any of the transactions described above, the identifier associated with a user account may take many different forms. In some embodiments, the identifier may be an account-specific identifier, such as an account number, username, or other account identifier. For example, a user of the access device may tell the relying party that “my identity repository number is 1008239.” Where multiple identity repositories may be operated, the identifier may include an identity repository designation. For example, a user of the access device may tell the relying party that “my OneID number is 1008239.” Some embodiments may use a non-numeric identifier, such as “my OneID account is ‘Steve’.” The identity repository may be used to ensure that the account-specific identifiers are unique across account holders.

In some embodiments, transaction-specific identifiers may also be used. A transaction-specific identifier may be generated by the access device, the identity repository, and/or the relying party device. Transaction-specific identifiers may offer the advantage of being short and easy to transfer between parties of the transaction. In some embodiments, the access device may receive a transaction-specific identifier from the identity repository. In other embodiments, the access device may generate a transaction-specific identifier using account-specific information, such as a private key. In some embodiments, the transaction-specific identifier may be generated as a function of characteristics of the transaction, such as time, amount, merchant, product, and/or the like.

In order to keep transaction-specific identifiers short, the identity repository may use a rolling register with identifiers that expire after a certain time interval. For example, a four digit identifier may be used that rolls over from 9999 to 0000. Some embodiments may use a location provided by the access device or the relying party device to resolve identifier collisions.

In some embodiments, different types of identifiers may be combined to form an overall identifier for the transaction. An account-specific identifier may be combined with a transaction-specific identifier to form an identifier for the transaction. For example, a user of the access device may provide a merchant with an account-specific identifier to which a transaction-specific identifier may be appended by either the access device or the relying party device. For example, the identifier “1008-1234” may be constructed from an account-specific identifier “1008” along with a transaction-specific identifier “1234.”

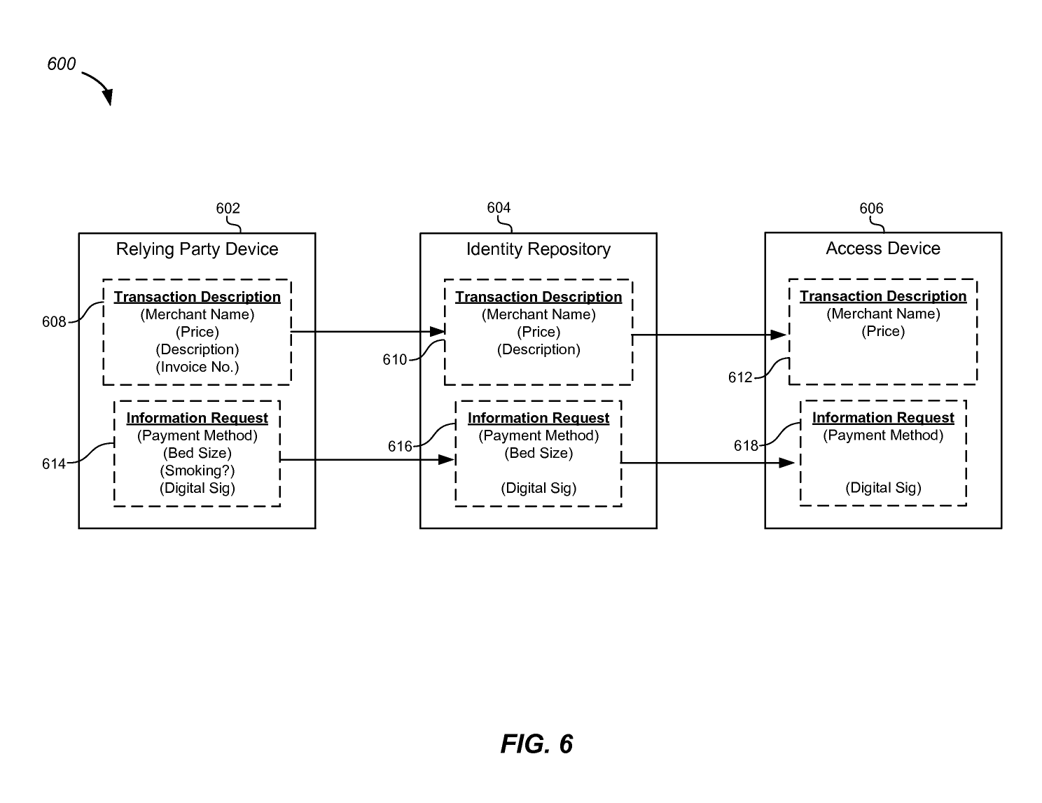

FIG. 6 illustrates a simplified block diagram 600 of information requests and transaction descriptions, according to one embodiment. In this embodiment, the relying party device 602 may provide different types of information. In some embodiments, the relying party device 602 may provide information that is descriptive of the transaction, or a transaction description 608. The transaction description 608 may include information describing the transaction such as a merchant name, a price, a tax amount, a product description, an invoice number, an SKU number, a product model, an address, a date, a time, and/or the like. The transaction description 608 may be sent to the identity repository.

The relying party device 602 may also send the information request 614, which may comprise types of information that need to be provided by the identity repository 604 and/or the access device 606 in order to complete a transaction. For example, the information request 614 may request that a payment method be selected and that product options be selected, such as a bed size, a room size, a clothing size, a product color, hardware options, and/or the like. The information request 614 may also include a request for a digital signature authorizing the transaction that will satisfy a credit card company or receiving bank.

In some cases, the relying party device 602 may provide some of the information needed by the information request 614. For example, a user of the access device may say to the merchant that he/she prefers a non-smoking room. This information may be received by the relying party device 602, and thus may not need to be sent to the identity repository 604. Alternatively, information that can be automatically determined by the relying party device 602 and/or determined by the merchant at a later time after the transmission is sent to the identity repository 604 need not be sent to the identity repository 604. Similarly, some portion of the transaction description 608 may be omitted from what is sent to the identity repository 604. For example, an invoice number or other internally used information may not be relevant to the identity repository 604.

The transaction description 608 and the information request 614 may be transmitted to the identity repository 604. The identity repository may store any information received in order to create a record of the transaction. Transaction records may be reviewed later by users in order to audit their spending or account usage.

The identity repository 604 may select a portion of the transaction description 610 and/or the information request 616 that should be sent to the access device 606. For example, an amount of the transaction description 610 may be sent such that the user can identify and authorize the transaction without being distracted by numerous details. Additionally, parts of the information request 616 may be filled by the identity repository 604, and thus need not be sent to the access device 606 for selections that have been made. As described above, some embodiments may elect to send information responsive to the information request 616 and provided by the identity repository 604 to the access device 606 such that a user may approve or alter the selections made by the identity repository 604.

Finally, some embodiments may display some, all, or none of the transaction description 612 sent to the access device 606. For example, the access device may simply display a merchant name and a price for authorization, even if additional information descriptive of the transaction is received. Similarly, the access device may display some, all, or none of the information request 618 sent to the access device 606. For example, the access device 606 may automatically provide information responsive to the information request 618, such as a digital signature using a private key or a preferred payment method.

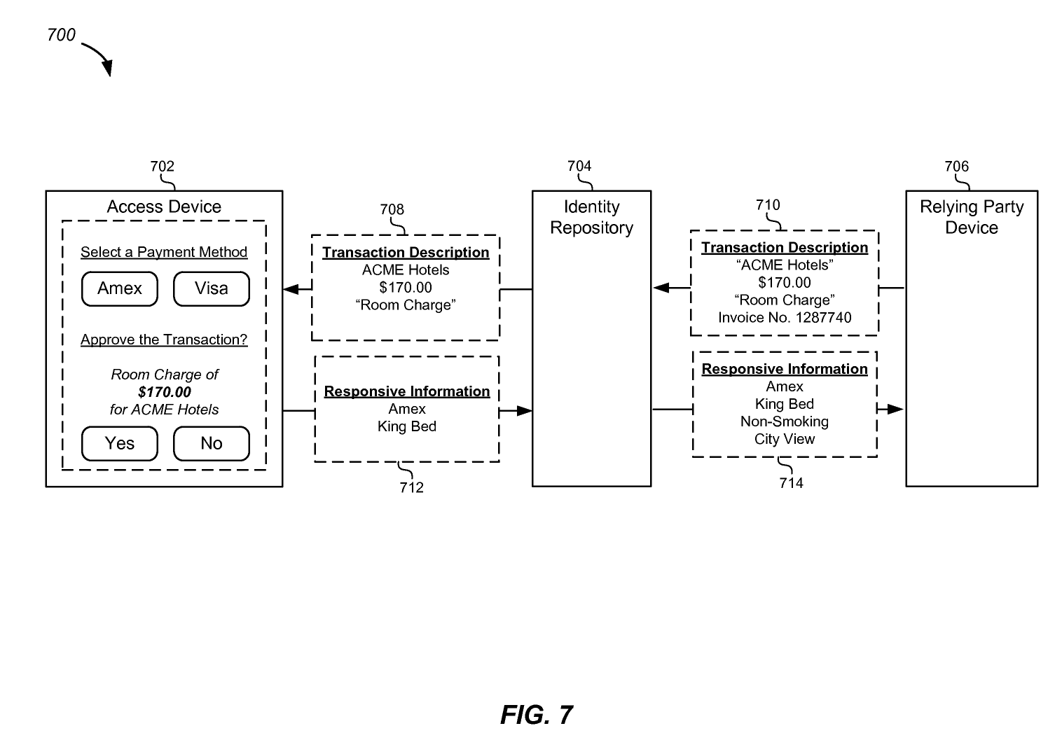

As information is returned from the access device 606 to the identity repository 604 and eventually to the relying party device 602, each device may add, subtract, or simply pass information through to the next entity. FIG. 7 illustrates a simplified block diagram 700 of information requests and transaction descriptions as used by various devices, according to one embodiment. This embodiment illustrates exemplary transaction descriptions and information requests that may be passed between entities in a transaction.

The relying party device 706 may send a transaction description 710 that includes the merchant name, the price, a description of the charge, and an invoice number to the identity repository 704. Next, the identity repository 704 may send a portion of the transaction description 708 that includes the merchant name, the price, and a description of the charge to the access device 702. Although not shown explicitly, the relying party device 706 may also send an information request for a selection of a payment method, a bed size, a smoking preference, and/or a room preference.

The access device 702 may display a portion of the information request and/or the transaction description 708 for a user. In this particular embodiment, the user may be prompted to select a payment method and may be presented with an opportunity to explicitly approve the transaction. In order to approve the transaction, portions of the transaction description 708 may be displayed to the user.

In response to a user input, the identity repository may receive a payment method selection provided by the access device 702 as part of the information responsive to the information request, or responsive information 712. In this embodiment, the access device 702 may provide, from a stored set of preferences, a bed preference as part of the responsive information 712. Additionally, the identity repository 704 may provide a smoking preference and a view preference from saved user preferences or default values for the responsive information 714 sent to the relying party device 706. Note that the descriptions, information requests, preferences, and/or specific transactions described in relation to FIG. 7 are merely exemplary, and not meant to be limiting.

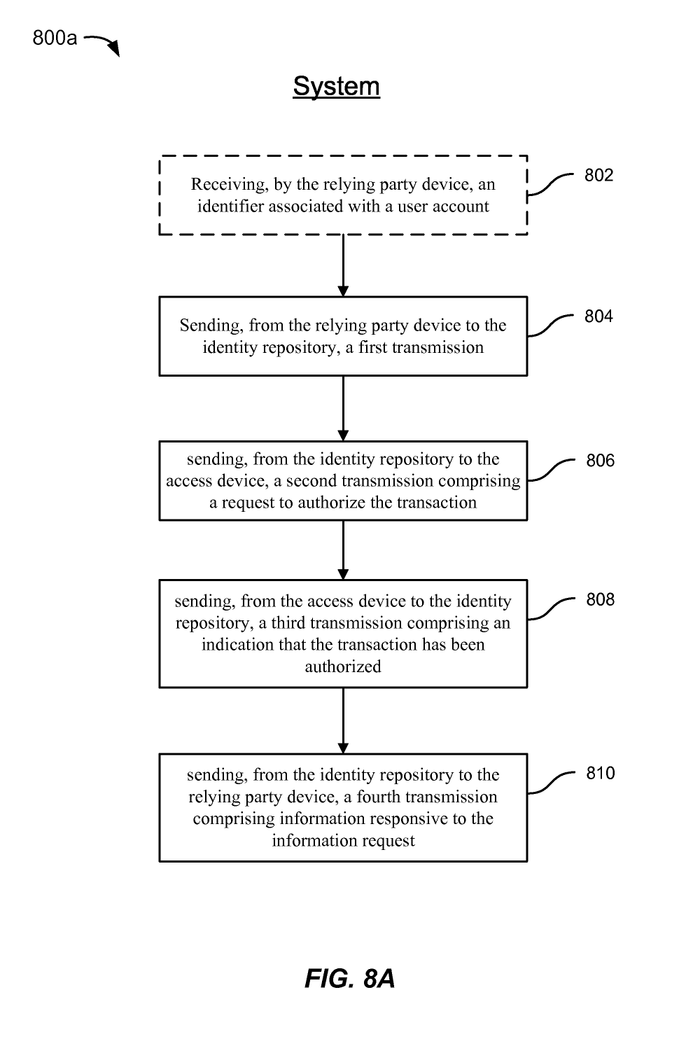

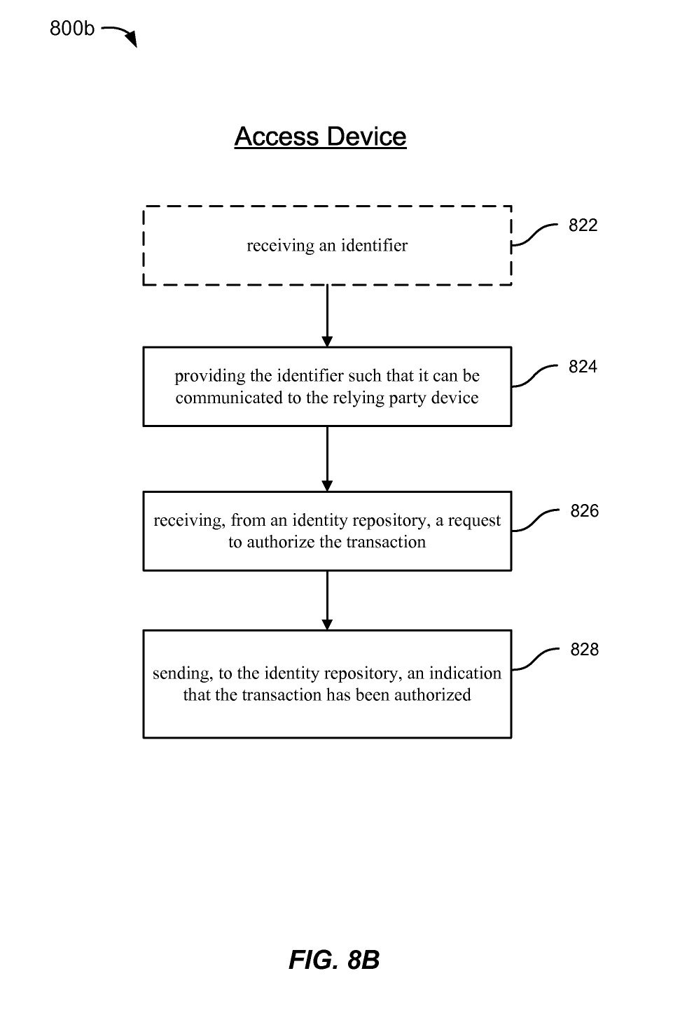

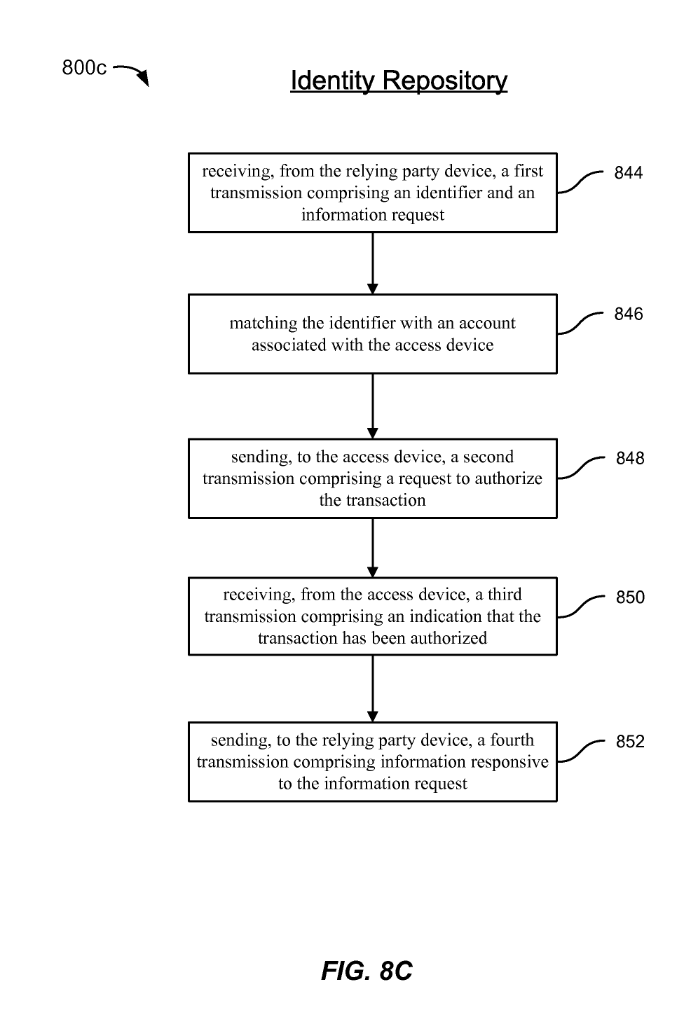

FIG. 8A illustrates a simplified flowchart 800a of a method of providing secure information for a transaction between an access device and a relying party device, according to one embodiment. This method may involve a system comprising an identity repository, and software modules operating on an access device and a relying party device. Optionally, the method may include receiving, by the relying party device, an identifier associated with a user account (802). As described above, other embodiments may generate an identifier at the access device. The identifier may be associated with the user account as an account-specific identifier or as a transaction-specific identifier.

The method may also include sending, from the relying party device to the identity repository, a first transmission (804). In some embodiments, the first transmission may include the identifier and an information request. In some embodiments, the identifier may be transmitted from the access device to the relying party device. This transmission may be verbal, aural, electronic, electromagnetic, and/or the like. In some embodiments, the first transmission may also include information descriptive of the transaction. For example, the method may include providing the identifier on an output device of the access device, and receiving the identifier from an input device of the relying party device. In this embodiment, the identifier may be received by a user of the access device, communicated to a user of the relying party device, and provided to the relying party device by the user of the relying party device.

The method may also include sending, from the identity repository to the access device, a second transmission comprising a request to authorize the transaction (806). The request for authorizing the transaction need not be explicit. In some embodiments, simply sending the transaction to be received by a software module operating on the access device may be interpreted as a request to authorize the transaction. Other embodiments may specify a set of criteria in order to authorize the transaction, such as a digital signature, a PIN, a biometric authorization, and/or the like. In some embodiments, the second transmission may also include at least a portion of the information request. The second transmission may further include the information descriptive of the transaction.

The method may also include sending, from the access device to the identity repository, a third transmission comprising an indication that the transaction has been authorized (808). The indication may comprise a digital signature, a tokenized credit card indicator, and/or the like. The third transmission may also include information responsive to the information request as provided by a user or the access device. The access device may provide such information from a set of stored user preferences.

The method may also include sending, from the identity repository to the relying party device, a fourth transmission comprising information responsive to the information request (810). The information responsive to the information request may be provided by the user, the access device, and/or the identity repository. In some embodiments, the identity repository may be geographically remote from the access device and geographically remote from the relying party device. In some embodiments, the identity repository may be a fully encrypted repository storing values in encrypted key/value pairs.

The method may further include other functions provided by the identity repository. One such function may be determining an LoA to be applied to the transaction and monitoring a set of requirements specified by the LoA. For example, an OOB authorization may be required based on an LoA provided by the relying party device and based on a price, time, location, and/or other characteristic of the transaction. In this case, the identity repository may send a second request to authorize the transaction to a control device. The control device may then send an indication that the transaction has been authorized to the identity repository. The indication sent from the control device may be verified using an PIN, a passcode, a password, etc.

FIG. 8B illustrates a simplified flowchart 800b of a method of providing secure information for a transaction to a relying party device using an access device, according to one embodiment. This particular method may be described from the point of view of the access device. In some embodiments, the method may include receiving an identifier (822). In other embodiments, the method may instead accept an identifier generated by the access device internally. The identifier may be received from the identity repository and may comprise a transaction-specific identifier.

The method may further include providing the identifier such that it can be communicated to the relying party device (824). For example, the access device may provide the identifier on a display. Also, the access device may electronically transmit the identifier to the relying party device. The transmission may take place by way of Bluetooth, 802.11, NFC technology, radio transmissions, infrared, and/or the like.

The method may additionally include receiving, from an identity repository, a request to authorize the transaction (826). In some embodiments, the request may be implicit, in that the transmission itself is interpreted as a request to authorize the transaction. In some embodiments, the access device may also receive information descriptive of the transaction and display the information descriptive of the transaction to a user. The user may provide an input authorizing the transaction, such as a biometric input, a signature, a voice authorization, and/or the like.

The access device may also receive a request for transaction information that is being requested by the relying party device. The access device may automatically provide some information responsive to the information request. The access device may also display a graphical representation that is descriptive of the request for transaction information to a user. The access device may then receive inputs from the user that include information responsive to the information request. This information may be sent to the identity repository.

The method may also include sending, to the identity repository, an indication that the transaction has been authorized (828). As described above, this authorization may comprise a digital signature, or any other form of authorization.

FIG. 8C illustrates a simplified flowchart 800c of a method of providing secure information for a transaction between an access device and a relying party device using an identity repository, according to one embodiment. This method may be carried out by the identity repository. The identity repository may include one or more processors, as well as a memory communicatively coupled with and readable by the one or more processors and comprising a sequence of instructions which, when executed by the one or more processors, cause the one or more processors to facilitate the transaction by carrying out the method steps.

The method may include receiving, from the relying party device, a first transmission comprising an identifier and an information request (844). The method may further include matching the identifier with an account associated with the access device (846). For example, the identity repository may use the identifier to match a specific account belonging to a user. In other embodiments, the identity repository may use the identifier to look up an account in a transaction table used to store various ongoing transactions.

The method may additionally include sending, to the access device, a second transmission comprising a request to authorize the transaction (848). The method may further include receiving, from the access device, a third transmission comprising an indication that the transaction has been authorized (850). The method may additionally include sending, to the relying party device, a fourth transmission comprising information responsive to the information request (852). Each of these method steps may be altered to include additional information, such as information descriptive of the transaction and information provided by the identity repository and/or the access device as described throughout this disclosure.

It should be appreciated that the specific steps illustrated in FIGS. 8A-8C provide particular methods of providing secure information for a transaction according to various embodiments of the present invention. Other sequences of steps may also be performed according to alternative embodiments. For example, alternative embodiments of the present invention may perform the steps outlined above in a different order. Moreover, the individual steps illustrated in FIGS. 8A-8C may include multiple sub-steps that may be performed in various sequences as appropriate to the individual step. Furthermore, additional steps may be added or removed depending on the particular applications. One of ordinary skill in the art would recognize many variations, modifications, and alternatives.

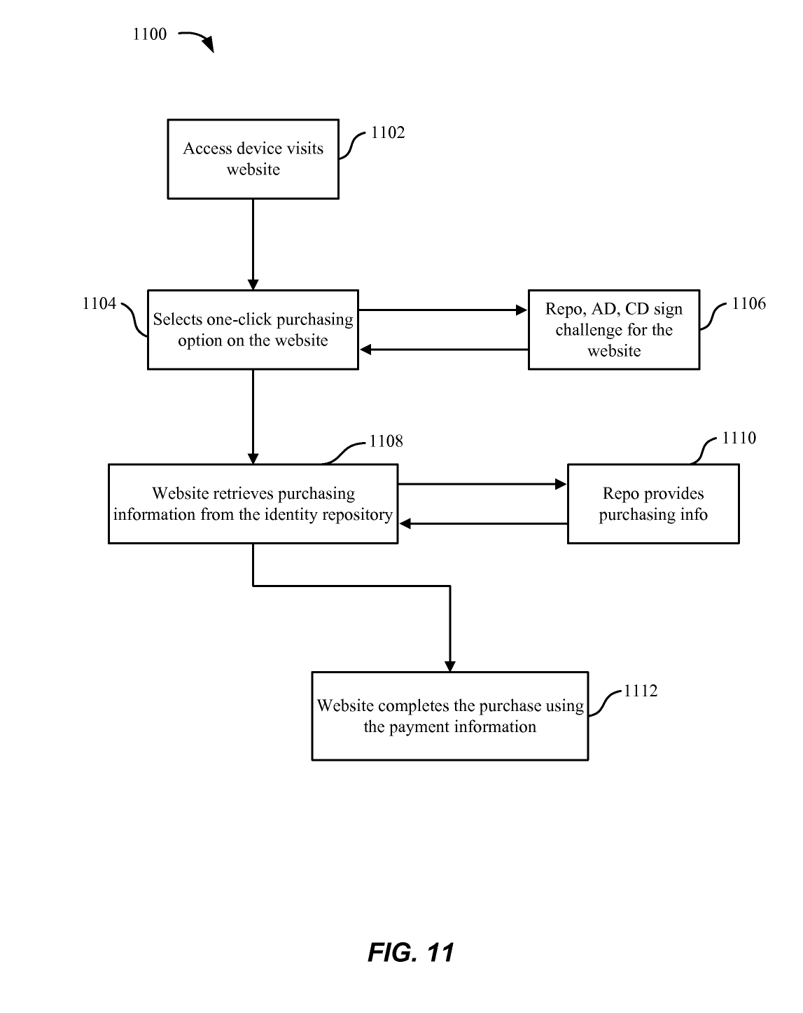

FIG. 11 illustrates a simplified flowchart 1100 of a method of implementing one-click purcahsing using the identity repository for a transaction between an access device and a website, according to one embodiment. In this embodiment, the principles discussed above for securely providing purchasing information to a merchant to complete a transaction may be leveraged in order to provide one-click purchasing on a website. This purchasing method may provide for a faster checkout procedure for both parties. This embodiment may also eliminate typographical errors resulting from repeated data entry of the same information for multiple websites. Using the identity repository for one-click purchasing also eliminates the need to store account information at the merchant website. For example, traditional one-click purchasing procedures access an account stored at the merchant website to retrieve a credit card number, shipping address, billing address, and any other information needed to complete the transaction. This data represents shared secrets that can be compromised en mass if the merchant systems are susceptible to an attacker.

The method may include using the access device to visit the website (1102). The access device may comprise a laptop computer, smart phone, desktop computer, and/or the like with a browser that is used to navigate to a website provided by the merchant. While accessing the website, the user of the access device may select products for purchase and place them in a virtual shopping cart. When the user finishes shopping and is ready to purchase the selected items, the website may provide various options to complete the transaction. One option may include selecting an existing account provided by the website. Another option may include establishing a new account or providing purchasing information for a one-time purchase.

In some embodiments, the method may also include selecting a one-click purchasing option provided by the website (1104). The one-click purchasing option may be associated with the identity repository. For example, the website may provide a button with a label such as “one-click purchasing with OneID.” The input control may include a specific identity repository. In other embodiments, the input control may simply indicate that one-click purchasing is available, and after it is selected, the website may provide a list of identity repositories participating in the one-click purchasing option.

In order to participate in one-click purchasing, the website may require that the user verify his/her virtual identity as provided by the identity repository. This procedure has been described above in great detail in the “Secure Identity Management” section of this disclosure. For example, the website may provide a digital challenge. The access device and the identity repository may sign the digital challenge using private keys that are stored locally and associated with the website. In cases where the selected LoA requirements dictate an OOB authentication, a control device may also provide a signature for the challenge. The signed challenge may then be returned to the website and verified using the corresponding public keys in order to verify the user's identity (1106).

When returning the signed challenge, the access device may also return a user identifier (GUID) that may be used to uniquely identify the user vis-à-vis the identity repository. In some embodiments, the website may then retrieve purchasing information from the identity repository (1108). The process for receiving secure purchasing information utilizing an identifier provided by the access device has been discussed in great detail in the sections above, and the same operations may be applied to one-click purchasing. For example, the website may provide an information request to the identity repository. The identity repository may provide any information stored thereon that is required for the purchase. Information not stored at the identity repository may be requested from the access device and possibly provided by the user. The identity repository may provide purchasing information that is responsive to the information request for use in the transaction (1110). The website may then use the purchasing information, such as a credit card number, billing address, shipping address, product options, and/or the like, in order to complete the transaction (1112).

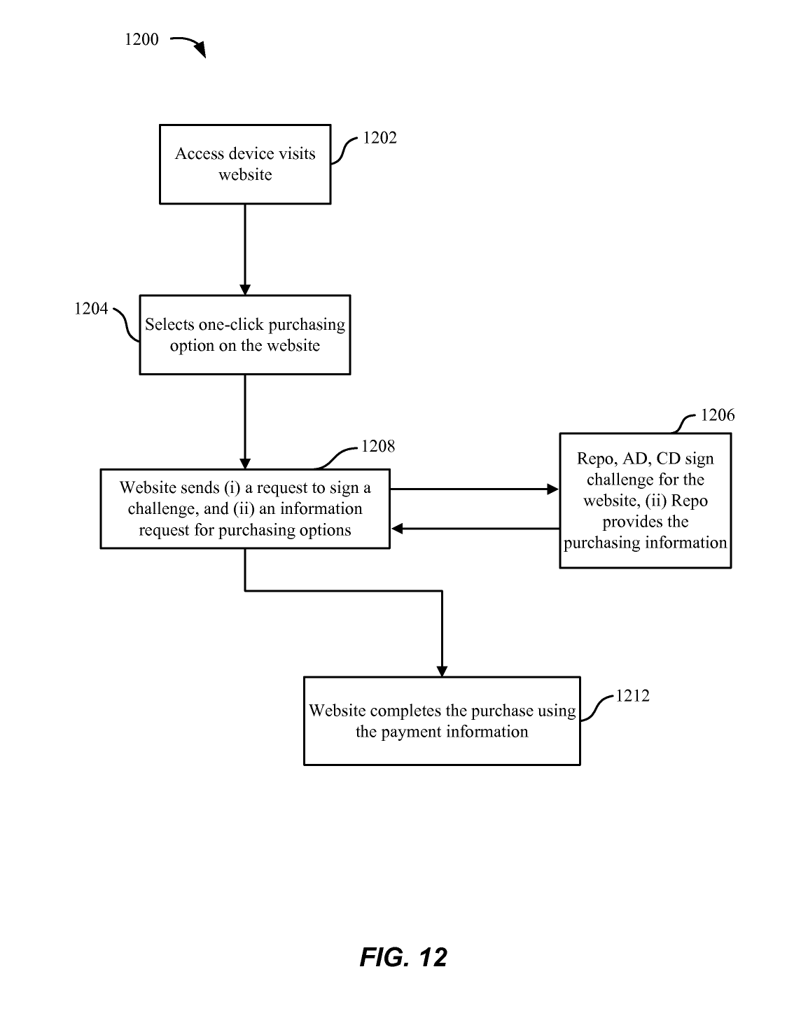

FIG. 12 illustrates a simplified flowchart 1200 of a method of implementing one-click purchasing using the identity repository for a transaction between an access device and a website, according to one embodiment. This embodiment may be very similar to the embodiment of flowchart 1100. However, in this embodiment the purchasing information required by the website may be requested as part of the user identity verification method.

As in the previous embodiment, the access device may visit the website (1202). After selecting products for purchase, the access device may select a one-click purchasing option on the website (1204). At this point, the website may send (i) a request to verify a virtual identity associated with the identity repository, and (ii) an information request comprising purchasing options that may be required to complete a purchase (1208). Purchasing options may include a credit card number, an expiration date, a billing address, and so forth.

The identity repository and access device may then follow procedures described elsewhere in this disclosure to both verify the virtual identity and provide information responsive to the information request. For example, the access device, identity repository, and possibly the control device may sign a digital challenge authorizing the transaction and verifying the user's identity. Additionally, the purchasing information may be formatted to match the encrypted field/value pairs stored at the identity repository. For example, a billing address may be formatted such that is compatible with the identity repository. The access device can then encrypt the billing address field to be sent to the identity repository. The identity repository may use the encrypted billing address field to return an encrypted billing address value. The encrypted billing address value may be decrypted by the access device using a key stored on the access device, and the decrypted billing address value may be sent back to the website as information responsive to the information request. After receiving the purchasing information and verifying the user's virtual identity, the website can use the purchasing information to complete the transaction (1212).

In some embodiments, the entire process of verifying the user's virtual identity and retrieving information responsive to the information request may be carried out by the web browser in the background such that the user need not be aware that these operations are taking place. From the user's perspective, clicking the one-click purchasing option input control may almost instantaneously complete the purchase. The user's identity can be automatically verified and information may be automatically encrypted, decrypted, and transmitted between the various devices in the transaction. Occasionally, the user may have to enter a PIN, password, or other form of passcode into the access device and/or the control device depending on the selected LoA requirements for the transaction. For example, a low value transaction may be completed without any user inputs aside from selecting the one-click purchase option. In contrast, a high value transaction may require a user to enter a PIN into a control device in addition to selecting the one-click purchasing option.

In some embodiments, this process may be implemented by causing JavaScript running using the identity manager's domain inside the browser to process the purchasing information requested by the merchant. The JavaScript can form the appropriate requests to get the information from the encrypted repository of the identity manager that stores the user's data. The identity manager's domain may then receive the encrypted information, decrypt it using the key is stored on the user's browser, and supply the decrypted information to the merchant. Note that unlike other one-click purchasing options, no manual login is required and the user never needs to leave the merchant's site.

In yet another embodiment implementing one-click purchasing, the transactions may may involve signing a digital invoice provided by the merchant. For example, after selecting the one-click purchasing option, the website may provide a digital invoice to the access device, wherein the digital invoice comprises a purchase amount, a merchant identifier, and/or the like. The access device and/or the identity repository may then provide signatures for the digital invoice. The signatures may be used to encode or specify a payment option, such as an account number. For example, a cryptographic key stored on the access device may be specifically associated with the user's Visa® credit card account.

Instead of providing a credit card account number to the merchant website to complete the transaction, the access device or the identity repository may return the signed digital invoice to the merchant or to a payment processing device, such as a translation gateway, a payment gateway, a bank computer system, and/or the like. The payment processing device may then verify the signatures on the digital invoice, extract payment information, account numbers, and a purchase amount from the signatures and the invoice, and complete the transaction. An indication may then be sent to the merchant that payment has been received, and the transaction may be completed. This embodiment may offer the advantage that a user's credit card information need never be disclosed to the merchant. Instead, the merchant can receive an indication from the bank servicing the user's Visa® credit card account that a payment has been made and accepted for the merchant. A complete description of processing digital invoices may be found in U.S. patent application Ser. No. ______, filed on the same date as the present application, entitled “Secure Digital Invoice Processing” (Attorney Docket No. 94276-868033(000610US)) and incorporated herein by reference for all purposes.

It will be understood that the embodiments described above for one-click purchasing options may be reordered, rearranged, and further subdivided into additional steps. It will also be understood that all of the features, variations, and principles of secure mobile transactions may be incorporated into the one-click purchasing methods described above.

The transactions described above represent exemplary embodiments. These transactions may be altered to accommodate many different payment scenarios. This disclosure will now described various alternate embodiments which the transactions described above may be altered by one having skill in the art in light of this disclosure.

In one embodiment, money may be donated to a party, such as a street merchant, using the identity manager. For example, the Payee may hold up a sign reading “if you want to tip me, my Identity Manager code is 1234.” The Payor then types in “1234”, then “$10”, then enters an optional descriptive note, and then clicks “Pay.” The Payee then sees the donation pop up on his relying party device.

In yet another embodiment, user authentication may be performed by the identity manager. This may be just like a payment with no value and with no need to go through a payment gateway. When the person signs an authentication transaction, the Relying Party (RP) will supply the domain to sign, rather than a financial transaction. For example, a bank teller may say “prove to me you are Steve.” Steve may then say “my Identity Manager number is 1008.” The bank teller then enters “1008.” The bank uses the Bluetooth protocol to send a nonce (an arbitrary number used only once to sign a cryptographic communication) with the bank domain name from the bank's terminal to Steve via Steve's Bluetooth server named something such as “IdentityManager-1008.” Steve determines the User ID (UID) to use, and signs the nonce with private keys associated with the UID used with that domain. The identity manager returns the UID and signatures and a repository to the Bank. The Bank then verifies the signature and knows that the person is Steve.

Other embodiments may enable remote payment and authentication. This may be similar to the scenario described above, except that the bank may determine that there is no Bluetooth server with that name. Instead, it asks a central pairing server for a unique entry starting with the identity manager ID, such as “1008-1234.” The bank may then tell Steve to enter “1234.” Thus, the bank and user can then communicate via the pairing repository using slot 1008-1234 through the identity manager rather than using a local Bluetooth connection.

In some embodiments, a user can define a set of conditions when user's phone must confirm the transaction using an out-of-band (OOB) device or a PIN. For example, if the transaction is greater than a certain amount, a cumulative number of transactions are greater than a certain amount, the transaction is in a new location, the transaction requires a tip, or the merchant requests an OOB verification may trigger this condition. In addition, a set of conditions may be provided that overrides the first conditions, such as “Grocery Store #112 and amount <$500.” When the transaction is presented to the payment network, all of these conditions may be calculated, and the user's device may be notified for the OOB approval, notes, and/or tip (if required). This may be used for both authentication and payments.

In a method according to one embodiment, a merchant may need to be authorized or the identity manager need not accept the transaction. This may be determined in real-time. Furthermore, a user can “disable” his Bluetooth server so it isn't listening for transactions, thus preventing anyone from transacting over the phone. Major banks may partner with the identity manager so that customers can directly access their bank balance so real time and withdraw funds from their account. Banks may promote to their customers benefits of banking with them, giving banks a reason to adopt this for competitive reasons. For example, a merchant may be allowed to pay a flat 2%+10 cent rate.

In one embodiment, this method may be implemented as follows. A server is either named something such as “identity manager 1008” or “identity manager” and 1008 comprises the password to get into the server. The Merchant might use a device such as a phone with Bluetooth communication ability. A listing of implicitly approved transactions may be provided, such as in cases where the customer has been to that merchant before and the transaction is less than a certain amount. Either the Payor or Payee can force the transaction require an OOB verification on the phone, e.g., to add a tip or customer notes.

Next, the Payee device may sign the transaction, the payment gateway may request an OOB verification if the conditions are met, and the gateway may prompt the phone for a PIN. In another embodiment, if the Payee inputs “no forced prompt,” or the transaction is for less than an amount, then a PIN may not be needed. Otherwise, the transaction may require confirmation so user can see how much he/she is being charged if the prompt condition is set.

In one embodiment, the identity manager may indicate how much money is left on an account. Additionally, the identity manager payment gateway may be instructed to treat an in-person transaction with a single signature as acceptable to process without a PIN. Also, the phone may have a counter, so it will prompt just on its local data. Or, the phone can ask the network (if it is available) for the most up-to-date data. This may be done when the merchant presents the payment, which should be soon after getting the digital signature.

In another embodiment, the Bluetooth code could be something such as “identity manager 4565” to be distinct. An NFC passive tag can also give this same name. Bluetooth or WiFi may be used. The key is to provide a semi-unique server name via voice, manual entry, NFC tag, QR code scan, bar code scan, etc. Also, there will be proof as to which device approved a transaction, and when it was approved. This proof may be a part of the transaction and can even include the serial number in it.

In another embodiment, in-person payment with a single pairing code may be provided. The method includes, for example, a Merchant requesting $20. The Payor may request using account 1008 of the identity manager. The Merchant inputs 1008 and an amount of the transaction into his identity manager app (possibly on an “accept payments” page). The Payor may open the phone to the identity manager and approve the transaction. The transaction may be displayed on the user's cell phone. If there are multiple transactions in the area within a certain time, the Payor may optionally add a comment or a tip and input “approve.” If a trigger condition is satisfied, the Payor may also have to enter a PIN code. Next, the transaction may show up as completed on the merchant's terminal, and the Payor may receive an electronic receipt (e.g., stored in the identity manager account or emailed to the Payor).

A trigger condition may be set by the user or the relying party. The user can set it based on conditions such as: “I've spent $X since the last time a PIN was entered,” “this transaction is >$Y,” “I've never paid your company before,” “this is more than 1 usually pay your company,” “more than H hours has transpired since I entered a PIN code,” etc. In this way, the user may positively confirm riskier transactions.

The location condition may not require a “geography change notification” feature for detecting location, and may work even if the payor and payee don't have GPS capability. It may use the names and/or MAC address of Bluetooth servers, Wi-Fi servers, etc. to find a commonality of location between the buyer and seller. Any overlap will be “within the area” of the seller. The commonality may be searched for by the payor's device at the time he/she opens the identity manager app to confirm the purchase.

These embodiment may offer certain advantages. The payor may remain anonymous, and the payee need not check pictures or learn the person's name to verify the identity. This can work at point-of-sale (POS) terminals at merchants without adding any new hardware. Simply setting up a Wi-Fi or Bluetooth server allows location information to be discovered by the client. A GPS, a GPS signal, or an “I moved to new location, wakeup the app” feature need not be required.

In an alternate embodiment, a more general purpose method may be provided. It may be used for over-the-phone authentication and authorization, whereas the previous method may work best when both parties are located in the same area. For example, the following transaction may take place. A phone order may total $25. The payor may elect payment using the identity manager and provide an identifier, such as the last four digits of his/her phone number. The payee may enter the number into the identity manager app or website and receive a transaction code, such as 5467. The payee may then tell the transaction code (5467) to the payor. The payor may then enter the transaction code into his/her identity manager app or website and approved the transaction. Note that this method mirrors current credit card transactions. For example, after giving the recipient an account number, they generate a transaction, which they then hand to the purchaser to physically sign and validate.

A more complex embodiment is illustrated by the following exemplary transaction involving a cab driver as follows. A passenger may pre-configure his identity manager to associate payments with a 4-digit code that the user chooses. Passenger gets one 4-digit code that is wired into his identity manager for mobile payments, e.g., 0000 or 1234, etc. The more unique the code, the shorter the resulting pair from the cab needs to be. The passenger can change this at any time. It need not be registered with the identity manager, but just pre-configured into his identity manager app so he doesn't have to enter it each time, but can just remember and say it to the cab driver. The passenger may then give the cab driver the last four digits of his phone number, e.g., “1008.” The cab driver may then use his identity manager app to enter in the 4-digits and amount to be charged. The amount typed may or may not include tip. (The passenger can add tip later.) The identity manager knows the cab driver's business name, cab driver name, etc. which it adds to the transaction. The cab driver can also add a description of the trip or the identity manager app can add the geo location of the current location of the cab.

The identity manager app may then use a pairing server to get a currently unique, worldwide number (for transactions which haven't completed or expired) ending in 1008. There may be a dictionary where 1008 is the key and the value is the next value in sequence which is incremented so it won't be used again until needed (and wraps when it hits 9999). If the sequence number is about to wrap to 0, but “0” is still unexpired, then the identity manager may move to extra digits for the 1008 prefix. This may occur when too many people are engaged in transactions at the current time, or it could also reduce the expiration time for the pairing codes using 1008. The driver may then tell the passenger the number he received from the pairing server, e.g., 1234. Note that the number can be shorter, e.g., 23. The passenger may then type in the pairing code received from the cab driver. This may cause a lookup at the pairing server on the string “1008-1234”. Note that if the passenger had given the cab driver 100 and the cab driver gave the passenger 81234, the pairing code lookup would be “100-81234”, which is different such that the “breakpoint” allows for different pairs.

In some embodiments, the passenger can optionally enter a “note” (e.g., “fare to city”), voice record a note, or categorize the transaction (e.g., “bill to client X”, “Personal”). The passenger may then decide whether to add a tip. In some embodiments, the cab driver may have already included the tip. The passenger may then authorize the transaction. This may add the Passenger's tokenized payment card (e.g., “Steve's VISA”) to the transaction, digitally sign the modified transaction using a private key on the phone associated with the Passenger (such as a control device), and may use the identity repository to sign as well. The passenger device may then be sent to the identity manager payment service to pay to the cab driver's account as specified in the digital invoice that the cab driver provided to the pairing repo.

The identity manager payment service may then send the payment to a payment network. At the payment service, the passenger's card may be looked up by the identity manager username and the tokenized name. The digital signature on the invoice, which specifies who is paid, the amount to be paid, details of the transaction, comments, and the unique transaction ID sequence number to prevent replay, may be verified using the digital signature that is associated with that card's tokenized name. The card may then be charged. Afterwards, the cab driver may receive a notification that the bill has been paid. A receipt may also notify the cab company specified by the invoice. The passenger may also receive an e-mail receipt of the transaction that includes the full details. The receipt may also be stored in his account at the identity manager.

Note that in the method of this embodiment, transactions may be removed (or considered expired) from the active table when (1) they've been paired and completed, (2) they are X minutes old, or (3) their pairing number was re-issued, possibly because the counter wrapped around. Generally, transactions may timeout a long time before being reused so the chance of a typo and hitting someone else's transaction by mistake is rare. Also, 9999 was merely an example. The rollover number could be 99999 if there are many transactions and a 5, 6, 7, etc. digit code is needed.

Furthermore, this embodiment may be applied to numerous situations, such as a waiter in a restaurant, etc. The tokenized card charged could be credit card, debit card with a PIN or an ACH transfer. As above, the passenger can set a cumulative dollar-amount threshold for transactions. If the transaction is over the threshold, the user may be required to enter a PIN code instead of just hitting “Approve.” This approves this transaction and sets the cumulative counter to 0. Thus, the user need not be bothered to enter the PIN each time.

Another more complex embodiment is illustrated by the following exemplary transaction involving a local merchant. This example assumes that the payor and payee (merchant) both have Internet connections and GPS. Thus, it may work with a cab driver, a flea market merchant, a restaurant with multiple waiters each simultaneously billing multiple tables, a supermarket, a coffee shop, etc.

A user may select items for purchase and present them to a cashier for a total purchase amount. The user may then provide an identifier for the identity manager, such as “1008.” Cashier types in 1008, sees a picture of Steve sent from the identity manager, submits the transaction, and gets approval of the transaction. At no time did the buyer have to reach for his phone or perform any action. All he had to do was say “1008.” The seller knows it is the right person using the picture confirmation, and only had to type in a 4-digit code. The buyer gets a receipt on his cell phone which he can view at any time in the identity manager app.

The user may remain anonymous to the seller, although he/she can reveal this information if he/she wants to. In very rare cases, there may be two identity manager matches, so the cashier has to either pick the right photo and/or ask the person for additional information, such as a first name. In addition, the buyer has several ways to further secure the transaction further if desired. For example, the user can change his 4-digit code at any time. The user can pick a longer code. The user can require an OOB/PIN approval every $X that is authorized this way. The user can make X smaller if desired, e.g., O. The user can require that OOB/PIN be used for purchases at new merchants. Note also, that someone finding his cell phone doesn't know his 4-digit number, and thus cannot access his identity manager account.

In yet another embodiment, a change in location may call the identity manager app on the user's phone, which in turn may inform the pairing server of the location, 4-digit pairing code of user, and register a digitally signed (by repo and CD) payment authorization on the user(s) credit cards and/or bank and/or debit cards. The identity manager may examine the GPS location of the merchant for any users around that area with the indicated 4-digit code. Ideally there is only one match. A merchant device may show the picture on file for that user and the first name to the merchant. Thereafter, the merchant can basically bill a pre-authorization that was on file with the identity manager payment gateway, which can also go to the bank.

If there are no people with the 4-digit code, then the search area around the merchant may be expanded up to a maximum distance of a threshold distance until a match is found. Merchants who fail to verify the user's identity using the picture data may be removed from the system. Ideally, fraud should be very low because the payor's cell phone may need to be in proximity of the merchant at the time of the transaction, the buyer must know payor's 4-digit code, and the picture-based identification limits thieves to those strongly resembling the user.

In order to user this embodiment, the merchant may enter his details, such as a name, address, phone, individual cashier/waiter name, and financial institution to credit with the payment (e.g., his VISA merchant account, MasterCard merchant account, ACH, or PayPal, etc.). The merchant may also enter his physical location or select “use GPS” if the Merchant is a cab driver or street merchant. Additionally, the merchant may put a pre-authorization into the identity manager payment gateway to approve these transactions. The user may pick which card(s) he wants to bill in order of preference. The identity manager may bill the first card that is also accepted by the Merchant.

In the embodiments discussed above, one way to execute the payments is via the identity manager's payment mechanism. At the time the user approves the payment, the user has the unique number of the payee, the amount, and his private keys. Therefore, the user may generate an invoice, digitally sign it, and send it to the identity manager gateway to be processed for payment to the payee. The gateway may verify the signature against the public keys on file for the payor. The payee may need to have pre-registered his payment account information to receive the payment with the identity manager payment gateway. Also, the user may be prompted for a PIN if the user's single transaction dollar amount is exceeded, or if the cumulative dollar amount is exceeded. For example, a PIN may be required for every $500 that is spent in order to protect against a lost cell phone that is unlocked.

In yet another embodiment, another method of transacting over a phone may be provided. If the purchaser has caller ID and is calling from any phone number that is registered to the identity manager, the merchant's computers will enter that phone number into his app as the user's phone number. The user may then bring up his app and approve the transaction, optionally adding a tip, a notation, etc.

Note that this works even if the phone is shared, because only the person who made the transaction will be opening his identity manager app and looking for the transaction to approve. Therefore, if Fred and Mary have the same home phone, and if Fred calls and makes a transaction, then that transaction will be viewable on Fred's phone and Mary's phone, but only Fred will be the one who is reaching for his phone at the time. Mary won't see it because she has no reason to look. However, to avoid any confusion, some embodiments may require Fred to enter a single 4-digit number configured into the identity manager app, such as the last four digits of a cell phone, and always use that number. This reduces confusion, using the same system every time.

In relation to the embodiments discussed above, numerous variations may be implemented depending on the various scenarios. Examples include the following. A cab driver may select his 4-digit number in advance so the user can enter that into his phone first and give cab driver the 4-digit code to enter into the cab driver's phone. This is similar to the technique previously described, just executed in the opposite order.

In another variation, one can treat numbers up to 999 as unique pairing codes that are distinct to individual people, as well as numbers of 6 digits or more registered to one's identity manager as the only person registered with that number. Therefore, a user can tell the cab driver “1” and the cab driver doesn't give a pairing code back because nobody else is allowed to use “1” except that user. Attackers can still try to hack the user by claiming they are “1”, but the user wouldn't approve their transactions. In this case, the user does may need to register his number with the identity manager so there is only one person that is allowed to use that number, which the cab driver's terminal then looks up and finds the pre-registered GUID and contacts his phone.

In another variation, the user can simply give the cab driver his identity manager number, or his complete phone number, or any other unique number associated with his identity manager account. This makes the transaction unique worldwide and works with all cases. The user knows this number well, so it should be easy to give out. Therefore, the user may only need to open his phone and the transaction is there to be approved and digitally signed. This method may work everywhere, but it may require more typing by the cab driver with a chance for error, requiring the user to possibly repeat that number again during transactions.

In another variation, the payor may need a cell phone to sign and authorize the transaction, but the payee may not need a cell phone. The payee can set a specific code number, sound to play, and/or a transaction serial number to know that the transaction is completed. For example, the user may enter the cab driver's unique 6-digit unique code, the amount, click pay, and the user phone may then play a sound and/or return a sequence number. The cab driver verifies the sequence number is correct, views the screen to see his logo and the amount of the transaction, and knows he has been paid. The payor should show the cab driver the phone which will show the cab driver's preregistered logo along with the amount of the transaction and the sequence number.

In another variation, instead of giving out numbers verbally, the user can use an NFC card, bar code, and/or a QR code, to transfer identifiers to the merchant. In other variations, the user only has to type enough digits to find the transaction. Thus, as soon as he/she types enough digits to locate the single active transaction with that pairing code, the transaction may be completed. For example, a small number of transactions reduces typing times; however, typos may link to someone else's transaction.

In another variation, the merchant could code his transactions to be “local”, and the user GPS could then locate the local transaction that matches. However, this may require both parties to have GPS, and both parties may have to specify the “local” option. The user's phone can look for matches with the same “local” identifier around his/her geo location. This may require the user to switch to a local setting vs. a national setting. In other cases, the user doesn't have to provide his/her phone number. Instead, he/she need not provide anything, in which case the merchant code may be 6 to 8 digits, or whatever length is currently is worldwide unique. Also, a cashier could use the individual cash register ID to be a part of the transaction.

In another variation on the above embodiments, when calling the user's bank, the user can utilize the identity manager to prove identity in the same way as when they are doing an in-person verification rather than payment. If the user calls, then the user could enter 1008 (his code) on the phone touch pad. For example, the bank could ask the user to enter 4567 on their phone. The Bank may likely require the user to enter a PIN in case someone steals the user's phone when left unlocked, so the user will have to re-enter the PIN if not recently entered in the phone, i.e., bank might ask for a PIN if not entered within the last 5 minutes. The Bank then knows who the user is because it receives at least two digital signatures: one from the user's identity repository (who verified the PIN was recently entered) and the other from the user's device.

When banking nationally over the phone, the same technique may be used, but the number sent to user may be longer. The setup may be the same, but the merchant require a national pairing code when giving out the number, in which case the merchant may cover a worldwide region when performing the matching with the user. Therefore, the search space may be greater than the geo location of the merchant. If equipped with caller ID, and there is an identity manager account with that caller ID, then it is likely the user himself that is calling. In this case, that may be all that is required. The caller may simply open his identity manager app, and the transaction is there, waiting to be approved. No code needs to be given to the user in that case.

In yet another variant, the embodiments discussed above may use phones that have less capability that some other smart phones. For example, suppose a phone has telephone features and a web browser, but no ability to run user-selected apps. Such a phone might use a browser and an HTML 5 local storage for the identity manager identity. The user could bookmark the web page to pay. The User may then decide if there is a condition that will require OOB verification.

In yet another variant, asynchronous authorization may be used in the embodiments discussed above. The user's phone may not have cell service when the user authorizes a transaction. This may be acceptable, as the system can skip over the user's pairing code a few times before re-assigning it. Therefore, the transaction stays “live” in the system until the user regains access to the identity repository. The transaction may then be approved. The pairing server may then call a “callback” URL registered by the merchant for such purposes with the signed invoice. The merchant can then present that invoice for payment by the identity manager network as is normally done for normal Internet purchase transactions using the identity manager.

Each of the methods described herein may be modified to incorporate the features described as part of these variants. For example, transactions described using a cabdriver device may be applied to over-the-phone transactions, bank transactions, and/or information passing transactions without limitation.

### Exemplary Hardware

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

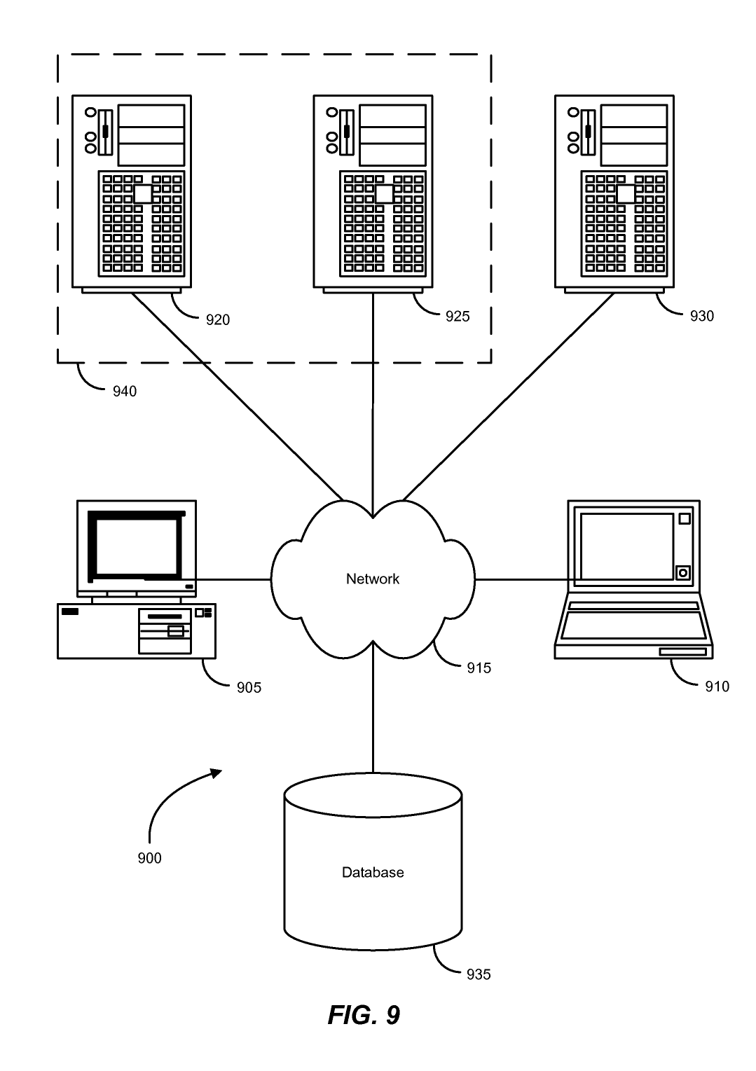

Each of the embodiments disclosed herein may be implemented in one or more computer systems. The computer systems can communicate with each other through a network. FIG. 9 is a block diagram illustrating components of an exemplary operating environment in which various embodiments of the present invention may be implemented. The system 900 can include one or more user computers 905, 910, which may be used to operate a client, whether a dedicated application, web browser, etc. The user computers 905, 910 can be general-purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 905, 910 may also have any of a variety of applications, including one or more development systems, database client and/or server applications, and web browser applications. Alternatively, the user computers 905, 910 may be any other electronic device, such as a thin-client computer, Internet-enabled mobile telephone, and/or personal digital assistant, capable of communicating via a network (e.g., the network 915 described below) and/or displaying and navigating web pages or other types of electronic documents. Although the exemplary system 900 is shown with two user computers, any number of user computers may be supported.

In some embodiments, the system 900 may also include a network 915. The network may can be any type of network familiar to those skilled in the art that can support data communications using any of a variety of commercially-available protocols, including without limitation TCP/IP, SNA, IPX, AppleTalk, and the like. Merely by way of example, the network 915 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 920, 925, 930 which can be general-purpose computers and/or specialized server computers (including, merely by way of example, PC servers, UNIX servers, mid-range servers, mainframe computers rack-mounted servers, etc.). One or more of the servers (e.g., 930) may be dedicated to running applications, such as a business application, a web server, application server, etc. Such servers may be used to process requests from user computers 905, 910. The applications can also include any number of applications for controlling access to resources of the servers 920, 925, 930.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 905, 910. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 905, 910.

In some embodiments, an application server may create web pages dynamically for displaying on an end-user (client) system. The web pages created by the web application server may be forwarded to a user computer 905 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 900 may also include one or more databases 935. The database(s) 935 may reside in a variety of locations. By way of example, a database 935 may reside on a storage medium local to (and/or resident in) one or more of the computers 905, 910, 915, 925, 930. Alternatively, it may be remote from any or all of the computers 905, 910, 915, 925, 930, and/or in communication (e.g., via the network 920) with one or more of these. In a particular set of embodiments, the database 935 may reside in a storage-area network (“SAN”) familiar to those skilled in the art. Similarly, any necessary files for performing the functions attributed to the computers 905, 910, 915, 925, 930 may be stored locally on the respective computer and/or remotely, as appropriate. In one set of embodiments, the database 935 may be a relational database, such as Oracle 10 g, that is adapted to store, update, and retrieve data in response to SQL-formatted commands.

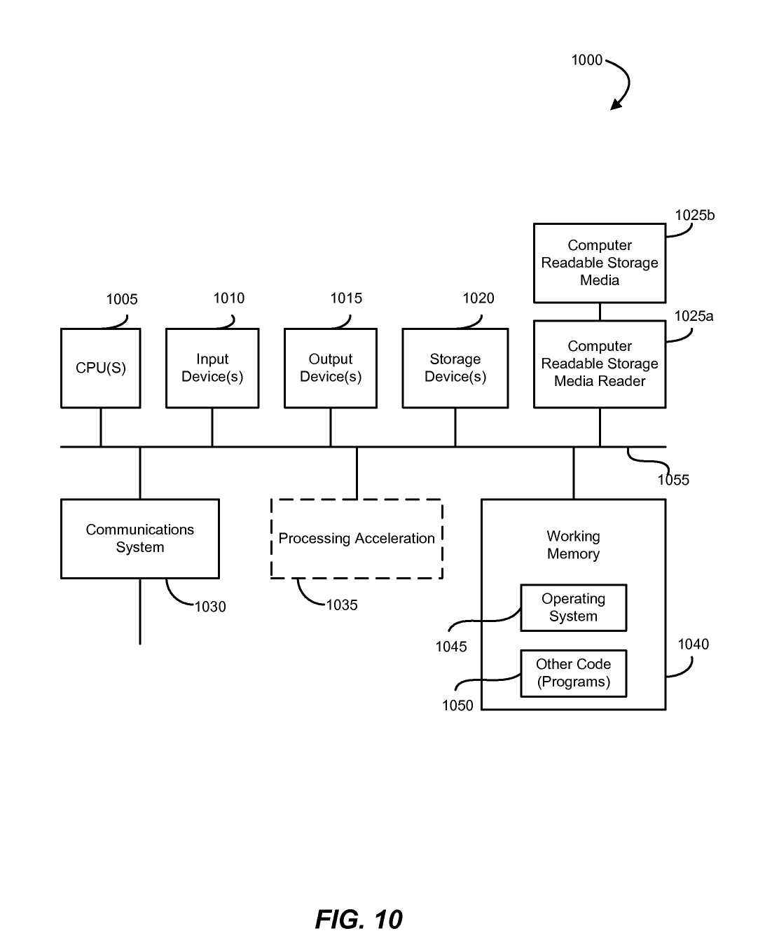

FIG. 10 illustrates an exemplary computer system 1000, in which various embodiments of the present invention may be implemented. The system 1000 may be used to implement any of the computer systems described above. The computer system 1000 is shown comprising hardware elements that may be electrically coupled via a bus 1055. The hardware elements may include one or more central processing units (CPUs) 1005, one or more input devices 1010 (e.g., a mouse, a keyboard, etc.), and one or more output devices 1015 (e.g., a display device, a printer, etc.). The computer system 1000 may also include one or more storage device 1020. By way of example, storage device(s) 1020 may be disk drives, optical storage devices, solid-state storage device such as a random access memory (“RAM”) and/or a read-only memory (“ROM”), which can be programmable, flash-updateable and/or the like.

The computer system 1000 may additionally include a computer-readable storage media reader 1025a, a communications system 1030 (e.g., a modem, a network card (wireless or wired), an infra-red communication device, etc.), and working memory 1040, which may include RAM and ROM devices as described above. In some embodiments, the computer system 1000 may also include a processing acceleration unit 1035, which can include a DSP, a special-purpose processor and/or the like.

The computer-readable storage media reader 1025a can further be connected to a computer-readable storage medium 1025b, together (and, optionally, in combination with storage device(s) 1020) comprehensively representing remote, local, fixed, and/or removable storage devices plus storage media for temporarily and/or more permanently containing computer-readable information. The communications system 1030 may permit data to be exchanged with the network 1020 and/or any other computer described above with respect to the system 1000.

The computer system 1000 may also comprise software elements, shown as being currently located within a working memory 1040, including an operating system 1045 and/or other code 1050, such as an application program (which may be a client application, web browser, mid-tier application, RDBMS, etc.). It should be appreciated that alternate embodiments of a computer system 1000 may have numerous variations from that described above. For example, customized hardware might also be used and/or particular elements might be implemented in hardware, software (including portable software, such as applets), or both. Further, connection to other computing devices such as network input/output devices may be employed. Software of computer system 1000 may include code 1050 for implementing embodiments of the present invention as described herein.

The following methods may be implemented by a computer system, such as computer system 1000 in FIG. 10. Each step of these methods may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of providing secure information for a transaction between an access device and a relying party device, the method comprising:
sending, from the relying party device to an identity repository, a first transmission comprising:
an identifier, wherein the identifier is associated with a user account and the user account is maintained by the identity repository; and
an information request;
sending, from the identity repository to the access device, a second transmission comprising a request to authorize the transaction;
sending, from the access device to the identity repository, a third transmission comprising an indication that the transaction has been authorized; and
sending, from the identity repository to the relying party device, a fourth transmission comprising information responsive to the information request.

2. The method of claim 1 further comprising sending, from the identity repository to the access device, the identifier, wherein the identifier comprises a transaction-specific identifier.

3. The method of claim 1 further comprising sending, from the identity repository to the access device, the identifier, wherein the identifier comprises a user-specific identifier.

4. The method of claim 1 further comprising transmitting, from the access device to the relying party device, the identifier.

5. The method of claim 1 further comprising:
providing the identifier on an output device of the access device; and
receiving the identifier from an input device of the relying party device, wherein:
the identifier is received by a user of the access device;
the user of the access device communicates the identifier to a user of the relying party device; and
the user of the relying party device provides the identifier to the input device of the relying party device.

6. The method of claim 1 further comprising:
sending, from the identity repository to a control device, a second request to authorize the transaction; and
sending, from the control device to the identity repository, a second indication that the transaction has been authorized.

7. The method of claim 1 wherein:
the second transmission further comprises at least part of the information request; and
the third transmission further comprises at least part of the information associated with the information request.

8. The method of claim 1 wherein the information responsive to the information request comprises values that are stored by the identity repository.

9. The method of claim 1 wherein:
the access device comprises a smart phone;
the identity repository is geographically remote from the access device; and
the identity repository is geographically remote from the relying party device.

10. The method of claim 1 wherein the first transmission further comprises information descriptive of the transaction.

11. A method of providing secure information for a transaction to a relying party device using an access device, the method comprising:
receiving, by the access device, an identifier;
providing the identifier such that it can be communicated to the relying party device;
receiving, from an identity repository, a request to authorize the transaction; and
sending, to the identity repository, an indication that the transaction has been authorized.

12. The method of claim 11 wherein:
the identifier is received from the identity repository; and
the identifier comprises a transaction-specific identifier.

13. The method of claim 11 further comprising:
receiving information descriptive of the transaction;
displaying the information descriptive of the transaction to a user; and
receiving an input from the user comprising authorization of the transaction.

14. The method of claim 13 wherein the information descriptive of the transaction comprises a price and a merchant name.

15. The method of claim 11 further comprising:
receiving an information request originating from the relying party device;
displaying a graphical representation that is descriptive of the information request to a user;
receiving an input from the user comprising information responsive to the information request; and
sending, to the identity repository, the information responsive to the information request.

16. The method of claim 15 wherein:
the information request comprises a request for a payment method; and
the information responsive to the information request comprises a selection of the payment method.

17. A system for providing secure information for a transaction between an access device and a relying party device, the system comprising:
one or more processors; and
a memory communicatively coupled with and readable by the one or more processors and comprising a sequence of instructions which, when executed by the one or more processors, cause the one or more processors to facilitate the transaction by:
receiving, from the relying party device, a first transmission comprising:
an identifier, and
an information request;
matching the identifier with an account associated with the access device;
sending, to the access device, a second transmission comprising a request to authorize the transaction;
receiving, from the access device, a third transmission comprising an indication that the transaction has been authorized; and
sending, to the relying party device, a fourth transmission comprising information responsive to the information request.

18. The system of claim 17 wherein the instructions further cause the one or more processors to facilitate the transaction by retrieving the information responsive to the information request from the account associated with the access device.

19. The system of claim 17 further comprising a fully encrypted repository storing encrypted field/value pairs, wherein the information responsive to the information request is stored by the identity repository as encrypted field/value pairs.

20. The system of claim 17 wherein the information responsive to the information request comprises a digitally signed authorization to charge a selected credit card account.
